(19) United States
(12) Patent Application Publication
(10) Pub. No.: US 2009/0252475 A1
(43) Pub. Date: Oct. 8, 2009

(54) Electronic Apparatus, Image Processing Method, Program, and Content Recording Medium

(76) Inventors: Hiroyuki CHIBA, Kanagawa (JP); Akihiko KINOSHITA, Tokyo (JP); Yoshiyuki KOBAYASHI, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/418,799

(22) Filed: Apr. 6, 2009

(30) Foreign Application Priority Data
Apr. 8, 2008 (JP) P2008-100234

(51) Int. Cl. H04N 5/91

(52) U.S. Cl. 386/83

(57) ABSTRACT

An electronic apparatus includes a reading unit configured to read, from a removable content recording medium on which at least one content item among a plurality of content items purchased by a user is recorded, playback rights information indicating that the plurality of content items can be played back, and position information indicating a recording destination of information regarding unrecorded content that is content that has not been recorded on the content recording medium; an obtaining unit configured to obtain the unrecorded content on the basis of the position information via a network; and a playback control unit configured to control playback of the obtained unrecorded content by using the playback rights information.

### BACKGROUND OF THE INVENTION

1. Field of the Invention

The present invention relates to an electronic apparatus, an image processing method, a program, and a content recording medium. More particularly, the present invention relates to an electronic apparatus capable of more easily viewing a plurality of cross-related content items, an image processing method therefor, a program therefor, and a content recording medium therefor.

2. Description of the Related Art

In a case where a user views cross-related content items, for example, some of a so-called series program, and thinks it is interesting, the user often thinks that he/she wants to further view other related content items. Accordingly, in order that the user can view other related content items, in a case where there is a recorded program that has not yet been viewed among programs related with the program being viewed, a recording and playback device that presents the recorded program as a recommended program to the user has been proposed (see, for example, Japanese Unexamined Patent Application Publication No. 2005-348153).

Furthermore, a technology is also in common use in which a user operates a recording and playback device and performs procedures for purchasing pay content, thereby causing the recording and playback device to download the purchased content from a server and play it back.

### SUMMARY OF THE INVENTION

Hitherto, in a case where a user is to view a plurality of cross-related pay content items, such as a series drama, it is necessary for the user to purchase an optical disc for each content item to be viewed or perform settlement of a purchase and cause a recording and playback device to download it.

For example, in a case where a user causes a recording and playback device to download pay content items provided by a server, it has been necessary for the user to perform a purchase procedure for each content item with regard to a plurality of cross-related content items. Furthermore, in this case, it is necessary for the user to perform complicated operations for searching for each content item to be viewed and downloading it.

It is desirable to be capable of more easily viewing a plurality of cross-related content items.

According to an embodiment of the present invention, there is provided an electronic apparatus including: reading means for reading, from a removable content recording medium on which at least one content item among a plurality of content items purchased by a user is recorded, playback rights information indicating that the plurality of content items can be played back, and position information indicating a recording destination of information regarding unrecorded content that is content that has not been recorded on the content recording medium; obtaining means for obtaining the unrecorded content on the basis of the position information via a network; and playback control means for controlling playback of the obtained unrecorded content by using the playback rights information.

The obtaining means may obtain update information informing that obtaining of the unrecorded content is possible on the basis of the position information, and may obtain the unrecorded content on the basis of the update information.

The electronic apparatus may further include display control means for controlling display of the update information obtained by the obtaining means.

The electronic apparatus may further include recording control means for controlling recording of the unrecorded content obtained by the obtaining means onto the content recording medium.

The electronic apparatus may further include recording means for recording the unrecorded content obtained by the obtaining means.

The electronic apparatus may further include recording means for recording the update information obtained by the obtaining means, wherein, when the obtaining means newly obtains update information, the obtaining means may obtain update information that has not been recorded on the recording means by transmitting, to the recording destination, information indicating the update information that has already been obtained and recorded in the recording means.

The electronic apparatus may further include recording control means for controlling recording of the obtained playback rights information on a content recording medium, wherein the obtaining means may obtain update information regarding another plurality of content items related with the plurality of content and may further obtain playback rights information on the other plurality of content items in such a manner as to correspond to the update information.

According to another embodiment of the present invention, there is provided an information processing method including the steps of: reading, from a removable content recording medium on which at least one content item among a plurality of content items purchased by a user, playback rights-information indicating that the plurality of content items can be played back, and position information indicating a recording destination of information regarding unrecorded content that is content that has not been recorded on the content recording medium; obtaining the unrecorded content on the basis of the position information via a network; and controlling playback of the obtained unrecorded content by using the playback rights information.

In an embodiment of the present invention, playback rights information indicating that a plurality of content can be played back, and position information indicating a recording destination of information regarding unrecorded content that is content that has not been recorded on a content recording medium are read from a removable content recording medium on which at least one content item among a plurality of content items purchased by a user is recorded. The unrecorded content is obtained on the basis of the position information via a network. Playback of the obtained unrecorded content is controlled by using the playback rights information.

According to another embodiment of the present invention, there is provided a content recording medium on which at least one content item among a plurality of content items purchased by a user is recorded, wherein the content recording medium has recorded thereon playback rights information indicating that the plurality of content items can be played back in an electronic apparatus to which the content recording medium is loaded, and position information indicating a recording destination of information regarding unrecorded content that is content that has not been recorded on the content recording medium.

In another embodiment of the present invention, playback rights information indicating that a plurality of content can be played back in an electronic apparatus to which a content recording medium is loaded, and position information indicating a recording destination of information regarding unrecorded content that is content that has not been recorded on the content recording medium are recorded on the content recording medium on which at least one content item among a plurality of content items purchased by a user are recorded.

According to the embodiments of the present invention, it is possible to more easily view a plurality of cross-related content items.

### BRIEF DESCRIPTION OF THE DRAWINGS

FIG. 1 shows an example of the configuration of a content providing system according to an embodiment of the present invention;

FIG. 2 shows an example of the configuration of a recording and playback device;

FIG. 3 illustrates recording and playback to and from an optical disc in EST (Electronic Sell Through);

FIG. 4 is a flowchart illustrating a playback process;

FIG. 5 is a flowchart illustrating a content updating process, an update information transmission process, and a content providing process;

FIG. 6 illustrates information included in update information;

FIG. 7 shows an example of update information;

FIG. 8 illustrates information included in package information;

FIG. 9 shows an example of package information;

FIG. 10 is a flowchart illustrating an additional content playback process;

FIG. 11 shows an example of the display of a menu screen;

FIG. 12 shows an example of the display of a list of update information;

FIG. 13 illustrates a BUMF;

FIG. 14 illustrates a BUMF;

FIG. 15 is a flowchart illustrating an additional content recording process;

FIG. 16 shows an example of the form of use of an optical disc;

FIG. 17 shows an example of the form of use of an optical disc;

FIG. 18 shows an example of the form of use of an optical disc;

FIG. 19 is a flowchart illustrating a content purchase process and a content sale process;

FIG. 20 illustrates a content updating process, an update information transmission process, and a content providing process;

FIG. 21 shows an example of a list of update information;

FIG. 22 is a flowchart illustrating a playback process and a registration process;

FIG. 23 is a flowchart illustrating a registration release request process and a registration release process; and

FIG. 24 shows an example of the configuration of a computer.

### DESCRIPTION OF THE PREFERRED EMBODIMENTS

Embodiments to which the present invention is applied will be described below with reference to the drawings.

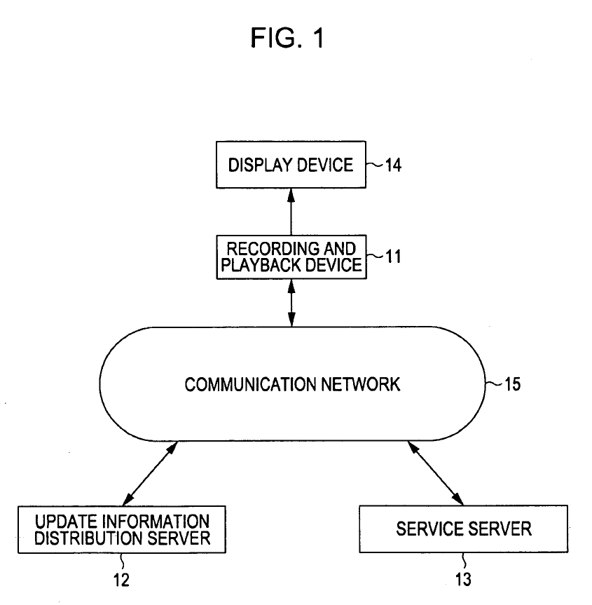

FIG. 1 shows an example of the configuration of a content providing system according to an embodiment of the present invention.

The content providing system includes a recording and playback device 11, an update information distribution server 12, a service server 13, and a display device 14, with the recording and playback device 11, the update information distribution server 12, and the service server 13 being interconnected with one another via a communication network 15 constituted by the Internet.

The display device 14 is connected to the recording and playback device 11. The user inserts an optical disc on which content has been recorded into the recording and playback device 11, making it possible to cause the recording and playback device 11 to play back content and display it on the display device 14. Furthermore, by using information read from the optical disc, the recording and playback device 11 obtains content update information related with the content recorded on the optical disc from the update information distribution server 12 or obtains content identified from the service server 13 using update information. The obtaining of the update information and the content is performed even in a state in which an optical disc is not inserted into the recording and playback device 11.

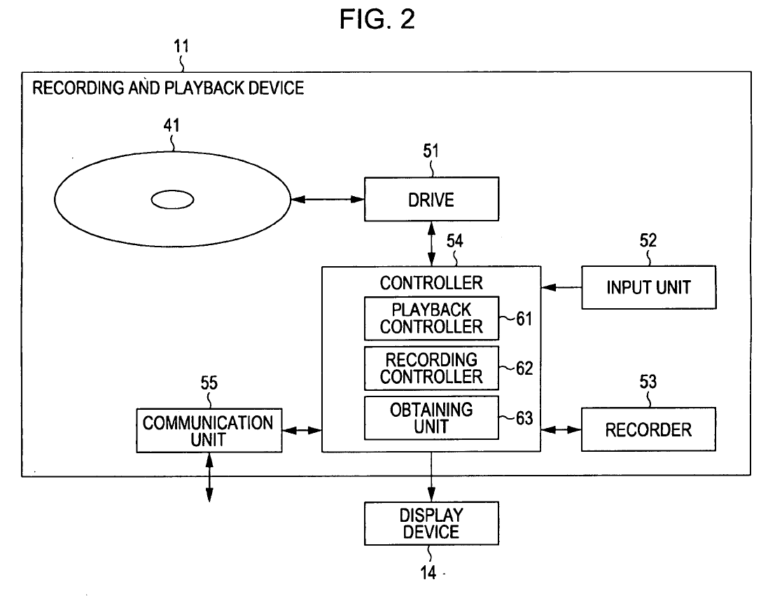

FIG. 2 is a block diagram showing an example of the configuration of the recording and playback device 11 of FIG. 1.

An optical disc 41 is loadable into and removable from the recording and playback device 11. The optical disc 41 is a data-writable optical disc, such as, for example, a BD-R (Blu-ray Disc (registered trademark of Sony Corporation) Recordable) disc or a BD-RE (Blu-ray Disc (registered trademark of Sony Corporation) Rewritable) disc. A recording medium that is loaded into and unloaded from the recording and playback device 11 is not limited to a Blue-ray disc as the optical disc 41, and may be an optical disc, such as a DVD (Digital Versatile Disc), or another recording medium as long as data can be written.

The recording and playback device 11 includes a drive 51, an input unit 52, a recorder 53, a controller 54, and a communication unit 55.

The drive 51 reads data, such as content from the optical disc 41 inserted into the recording and playback device 11 and supplies the data to the controller 54, or writes data supplied from the controller 54 on the optical disc 41 under the control of the controller 54.

The input unit 52 includes, for example, buttons and a light-receiving unit for light-receiving a signal from a remote commander with which the user performs an operation on the recording and playback device 11, and supplies an operation signal in response to the operation of the user to the controller 54. The recorder 53 includes, for example, a hard disk where various kinds of data, such as content supplied from the controller 54, image data of GUI (Graphical User Interface) to be displayed on the display device 14, are recorded. This recorder 53 is used as a local storage of the recording and playback device 11.

The controller 54 controls the entire operation of the recording and playback device 11 in response to an operation signal from the input unit 52.

The controller 54 includes a playback controller 61, a recording controller 62, and an obtaining unit 63. The playback controller 61, the recording controller 62, and the obtaining unit 63 are realized as a result of, for example, the controller 54 executing a program recorded in the recorder 53 as necessary or executing a program read from the optical disc 41 and supplied from the drive 51.

The playback controller 61 controls the playback of content recorded on the optical disc 41 and the recorder 53. For example, the playback controller 61 decodes encrypted content as necessary and supplies the content to the display device 14. The recording controller 62 controls recording of data, such as content, onto the optical disc 41. Furthermore, the obtaining unit 63 obtains content related with the content recorded on the optical disc 41, and update information on the content from the update information distribution server 12 and the service server 13 via the communication unit 55 and the communication network 15.

Here, the update information is information to be notified to a user, which is related with the content recorded on the optical disc 41 and is, for example, information in a predefined predetermined format, such as an RSS (Resource Description Framework Site Summary) format or an ATOM format.

For example, the update information includes information that notifies the user that new content (for example, content of a series new work), which is content related with the content recorded on the optical disc 41 and which can be viewed by downloading from the service server 13, is added and can be obtained. Furthermore, the update information also includes information stating that new subtitles and making video are added in the content recorded on the optical disc 41, information regarding other related content whose providing source is common, and the like.

The communication unit 55 communicates with the update information distribution server 12 and the service server 13 via the communication network 15, supplies data received from the update information distribution server 12 and the service server 13, and the like to the controller 54, or transmits the data supplied from the controller 54, and the like to other devices.

On the optical disc 41, some of the content of a plurality of cross-related content items, which were purchased by the user, are recorded. For example, the user purchases one series disc (optical disc 41) from which the user can view the first to fifth stories. On the series disc (optical disc 41), the moving image data of the first story that has already been released when the disc was purchased within the moving image data from the first to fifth stories of the drama has been recorded in advance. Therefore, after the moving image data from the second to fifth stories is released in sequence, the moving image data is downloaded from the service server 13 and is recorded in accordance with a specification of EST (Electronic Sell Through) or the like.

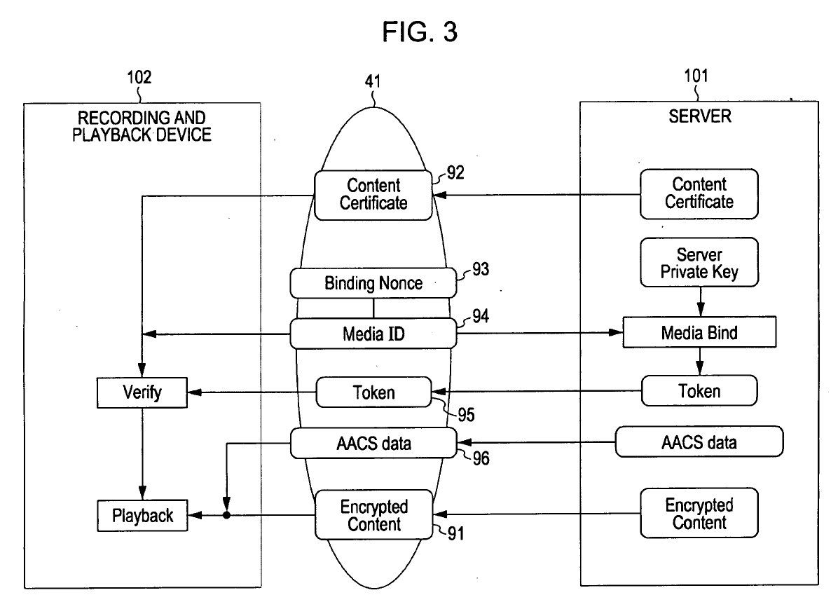

In a case where content is to be additionally recorded on the optical disc 41 in accordance with the specification of EST, as shown in, for example, FIG. 3, the user purchases the optical disc 41 on which, in addition to encrypted content 91, a certificate 92, random data 93, a media ID (Identification) 94, a token 95, and AACS (Advanced Access Content System) data 96 have been recorded in advance.

Here, the content 91 is, for example, the moving image data of the first story among first to fifth stories of the series work drama purchased by the user. The certificate 92 is an electronic certificate indicating that the moving image data from the first to fifth stories can be purchased. The certificate 92 is issued by a server 101 corresponding to the service server 13.

The random data 93 is a random number recorded on the optical disc 41 by the server 101. The media ID 94 is identification information specific to the optical disc 41. The token 95 is rights information to the effect of having the rights of playing back the content 91, and content that is additionally recorded on the optical disc 41, that is, moving image data from the first to fifth stories. The token 95 is generated from predetermined data possessed by the server 101, the random data 93, and the media ID 94.

The AACS data 96 is data, such as a decoding key (common key) defined by the specification of AACS, and is used when the content 91 or content that is additionally recorded on the optical disc 41 is played back. That is, the AACS data 96 includes a decoding key used for decoding the content 91 or content that is additionally recorded.

The user inserts the purchased optical disc 41 into a recording and playback device 102 corresponding to the recording and playback device 11 and instructs the playback of the content 91, making it possible to play back the content 91.

When the content 91 is to be played back, the recording and playback device 102 reads, from the optical disc 41, the certificate 92, the random data 93, the media ID 94, and the token 95, and confirms that the content 91 is reproducible content that has been purchased in an authorized manner on the basis of these items of read information. More specifically, the recording and playback device 102 computes a hash value of data of a predetermined value recorded in the recording and playback device 102 in advance, the certificate 92, the random data 93, and the media ID 94, and compares the obtained value with the token 95.

When the value of the hash value matches with the value of the token 95 and the content is confirmed to has been purchased in an authorized manner, the recording and playback device 102 further reads the content 91 and the AACS data 96 from the optical disc 41. Then, the recording and playback device 102 decodes the content 91 by using the AACS data 96 and plays back the content 91.

After the user purchases the optical disc 41, when a state is reached in which the remaining content, that is, content that is additionally recorded on the optical disc 41, which is purchased by the user, can be downloaded newly, the recording and playback device 102 downloads the content from the server 101 in accordance with instructions from the user. Then, the recording and playback device 102 records the downloaded content on the optical disc 41. As a result, it becomes possible for the user to view not only the content 91 but also all the purchased content, for example, all of the first to fifth stories of the drama by using the optical disc 41.

Hereinafter, content that has been recorded in advance on the optical disc 41 will also be referred to as recorded content, and content that is additionally recorded on the optical disc 41, which is purchased by the user, will also be referred to as additional content.

When the user purchases the optical disc 41 on which the certificate 92 for the content 91 as recorded content and the additional content are recorded, the user inserts the optical disc 41 into the recording and playback device 11, thereby causing the recorded content to be played back. When the optical disc 41 is inserted and an operation signal instructing the playback of the recorded content is supplied from the input unit 52, the recording and playback device 11 performs a playback process so as to play back the recorded content.

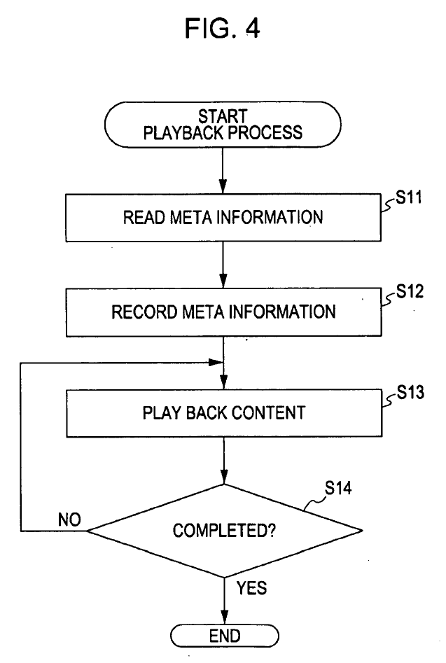

A description will be given below, with reference to the flowchart of FIG. 4, of a playback process performed by the recording and playback device 11.

In step S11, the drive 51 reads meta-information of the recorded content from the optical disc 41 inserted into the recording and playback device 11. Here, the meta-information to be read is meta-information of the recorded content that has been recorded on the optical disc 41.

For example, the meta-information includes content information, a feed URL (Uniform Resource Locator), access frequency information, access authentication information, an org ID, and a disc ID.

The content information is information that includes the title of the recorded content, a jacket image of the title, that is, a so-called thumbnail image, and the like. The content information is used when library information that is a list of content items that were played back in the past is to be displayed on the display device 14.

The feed URL is position information written in a URL format, which indicates the recording destination of the update information, that is, the position at which the update information in the update information distribution server 12 is recorded. Therefore, the feed URL is set as information different for each title of content. Hereinafter, position information described in a URL method will be referred to simply as a URL.

The access frequency information is information indicating a time at which the recording and playback device 11 accesses the update information distribution server 12 and the frequency, in more detail, accesses the update information, and is set as, for example, information informing that access is made at 12 o'clock once in a week. Furthermore, the access authentication information is information necessary for user authentication, which is performed when the recording and playback device 11 accesses the update information, for example, information formed of the user ID, the password, and the authentication method of the user, which has been registered in advance in the update information distribution server 12. The org ID is identification information for identifying the provider of the title of the recorded content, and the disc ID is identification information for identifying the title of content.

When meta-information is read from the optical disc 41, the drive 51 supplies the read meta-information to the controller 54. The controller 54 supplies the meta-information supplied from the drive 51 to the recorder 53.

In step S12, the recorder 53 records the meta-information supplied from the controller 54 in accordance with the instructions from the controller 54.

In step S13, the playback controller 61 of the controller 54 plays back the recorded content in response to the operation of the user. That is, the playback controller 61 causes the drive 51 to read content from the optical disc 41 in response to an operation signal from the input unit 52, and obtains the read content from the drive 51. Then, the playback controller 61 performs predetermined processing, such as decoding, as necessary on the content supplied from the drive 51, and supplies the content to the display device 14, whereby the content is displayed on the display device In more detail, during the playback of the recorded content, the playback controller 61 confirms whether or not the content to be played back is authorized content by using the certificate., the random data, the media ID, and the token, which are read from the optical disc 41. Furthermore, the playback controller 61 decodes the recorded content by using AACS data read from the optical disc 41. Furthermore, the playback controller 61 performs processing, such as halt or stop of the playback of content in response to the operation of the user.

In step S14, the playback controller 61 determines whether or not the playback of the recorded content should be completed.

For example, in a case where the user instructs that the playback of the recorded content be stopped, it is determined in step S14 that the playback should be completed.

When it is determined in step S14 that the playback should not be completed, the process returns to step S13, and the above-described processing is repeated. In more detail, a process for confirmation is not performed for content that has been confirmed once to be authorized in step S13, and only processing necessary for playback, such as the decoding of content, is performed.

In comparison, when it is determined in step S14 that the playback should be completed, each unit of the recording and playback device 11 completes processing being performed, thereby completing the playback process.

As described above, when the optical disc 41 is inserted, the recording and playback device 11 reads meta-information from the optical disc 41 and records it in the recorder 53.

As described above, by reading meta-information and recording it in advance, it is possible to access the update information distribution server 12 by using the feed URL contained in the meta-information and obtain update information. That is, it becomes possible for the recording and playback device 11 to obtain update information and present it to the user in a state in which the optical disc 41 is not inserted into the recording and playback device 11. As a consequence, it becomes possible for the user to easily and quickly know information related with recorded content and additional content, such as whether additional content has been released (sold) and is available for viewing without particularly necessitating an operation.

When the meta-information of the content recorded on the optical disc 41 is recorded in the recorder 53 as a result of the playback process, the recording and playback device 11 periodically accesses the update information distribution server 12 on the basis of the access frequency information included in the meta-information and obtains the update information. When the additional content is newly recorded in the service server 13 and the additional content is available for viewing, the recording and playback device 11 obtains the additional content from the service server 13 on the basis of the obtained update information.

Furthermore, the update information distribution server 12 and the service server 13 perform a process for providing update information and additional content to the recording and playback device 11 in response to a request from the recording and playback device 11.

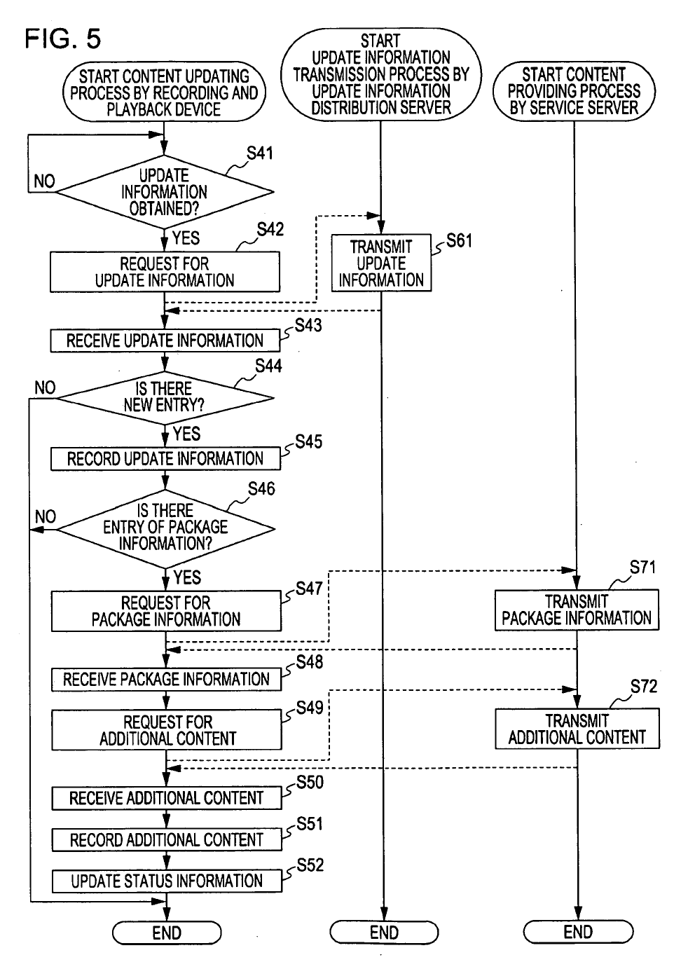

A description will be given below, with reference to the flowchart of FIG. 5, of a content updating process performed by the recording and playback device 11, an update information transmission process performed by the update information distribution server 12 and a content providing process performed by the service server 13.

In step S41, the obtaining unit 63 of the recording and playback device 11 determines whether or not update information should be obtained on the basis of the access frequency information included in the meta-information of the recorded content recorded in the recorder 53. For example, the obtaining unit 63 constantly performs a timer operation. When the time has arrived at which access to the update information is made, which is specified by the access frequency information, it is determined that the update information should be obtained.

In more detail, when the time has come at which the update information should be accessed, in the case that the content specified using the org ID and the disc ID, which are included in the meta-information, that is, the content of the optical disc 41 from which these IDs were read, is being played back, it is determined that the update information should not be obtained. As a result, it is possible to avoid competition between a process for obtaining additional content and a process for obtaining update information, which have been designated by a user operation.

In a similar manner, when the time has come at which the update information should be accessed, also in the case that the processing of a function of managing the recorder 53, such as the deletion of content recorded in the recorder 53 is being performed, it is determined that the update information should not be obtained to avoid competition between processings.

When it is determined in step S41 that the update information should not be obtained, the process returns to step S41, and a determination process is repeated until it is determined that the update information should be obtained.

In comparison, when it is determined in step S41 that the update information should be obtained, in step S42, the obtaining unit 63 requests the update information distribution server 12 to transmit the update information. That is, the obtaining unit 63 reads the feed URL and the access authentication information included in the meta-information from the recorder 53, and transmits the feed URL and the access authentication information to the update information distribution server 12 via the communication unit 55, thereby accessing the recording destination of the update information indicated by the feed URL.

When the recording and playback device 11 requests the update information distribution server 12 for update information, in step S61, the update information distribution server 12 transmits the update information to the recording and playback device 11 in response to the request from the recording and playback device 11.

That is, the update information distribution server 12 receives the feed URL and the access authentication information that have been transmitted from the recording and playback device 11, and performs authentication of whether or not the user is a pre-registered user by using the received access authentication information. When the authentication is performed, the update information distribution server 12 transmits the update information identified by the received feed URL to the recording and playback device 11 via the communication network 15, and the update information transmission process is completed.

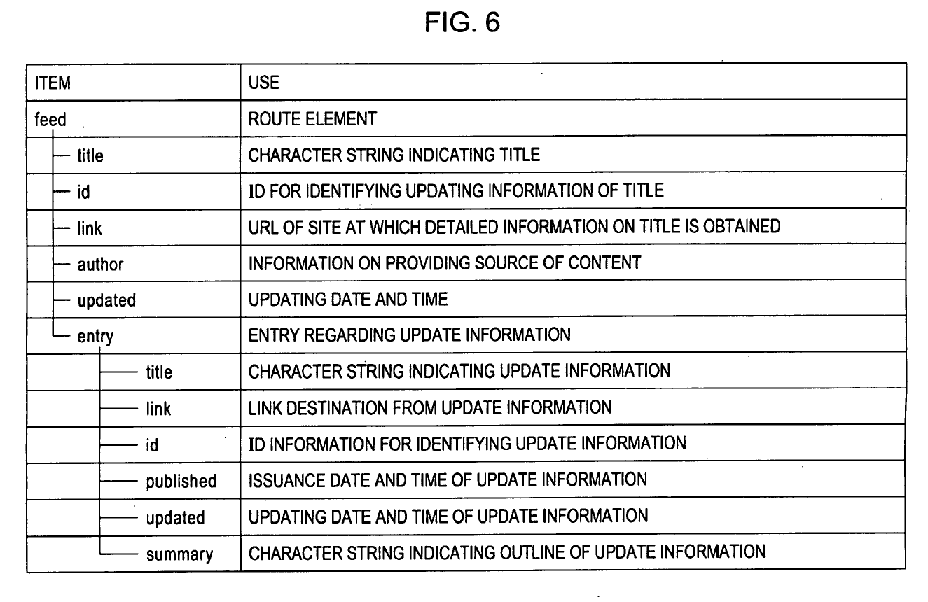

For example, in a case where the update information recorded by the update information distribution server 12 is information in an ATOM format, in more detail, in a case where the update information has been included in the transmission information in an ATOM format, the information of each item shown in FIG. 6 is included in the transmission information.

In FIG. 6, in the column of the left side in the figure, each item included in the transmission information is shown, and in the column of the right side in the figure, a description of the information of each item is shown. That is, the transmission information transmitted from the update information distribution server 12 to the recording and playback device 11 is provided with the item of “feed” in which other items are stored as root elements, and in the item “feed”, information on the items of “title”, “id”, “link”, “author”, “updated”, and “entry” is stored.

In the item “title”, a character string indicating the title of the recorded content of the optical disc 41 is stored, and in the item “id”, an ID (identification information) indicating update information regarding the title of the recorded content is stored. The identification information stored in the item “id” is set in such a manner that the org ID and the disc ID contained in the meta-information of the recorded content of the optical disc 41 are arranged.

In the item “link”, a URL indicating the recording destination of a Web page at which detailed information regarding the title of the recorded content is obtained is stored. In the item “author”, information on the providing source of the recorded content on the optical disc 41 is stored, and in the item “updated”, information indicating the updating date and time of transmission information is stored. Furthermore, in the item “entry”, information on each item included in the transmission information is stored.

Here, the entry refers to one item of update information that is notified to the user, such as additional content being sold (released) and available for download. In a case where a plurality of items of update information are included in the transmission information, items “entry” are stored, in the item “feed”, in a number corresponding to the number of items of update information.

In the item “entry”, information on the items of “title”, “link”, “id”, “published”, “updated”, and “summary” is stored.

In the item “title”, a character string indicating update information is stored. In the item “link”, information indicating the link destination regarding update information is stored. In the item “id”, an ID for identifying update information is stored. In the item “published”, information indicating issuance date and time is stored, and in the item “updated”, information indicating updating date and time is stored. Furthermore, in the item “summary”, a character string indicating the summary of the update information is stored.

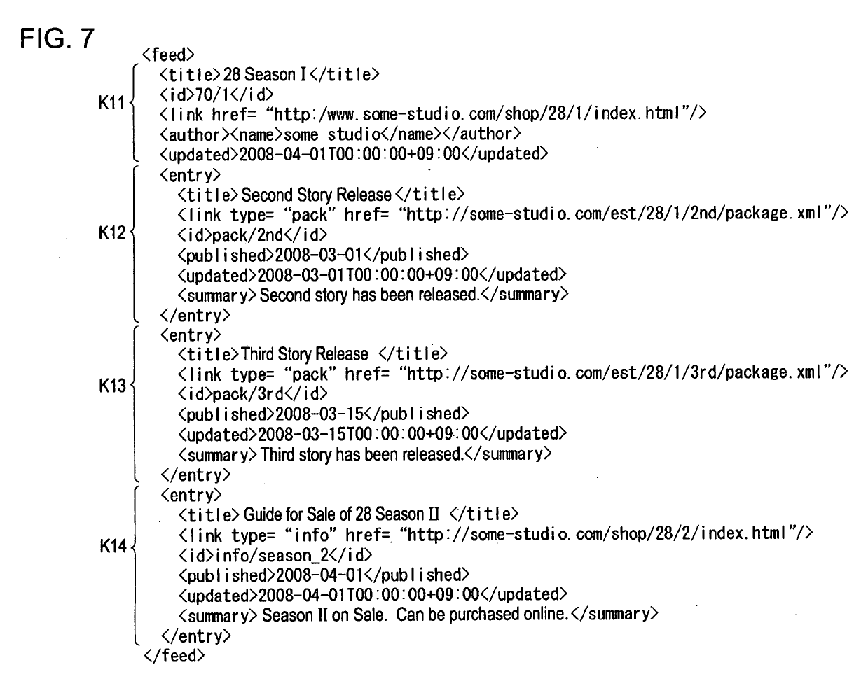

The transmission information in which each item shown in FIG. 6 is included is more specifically set to be information shown in, for example, FIG. 7. In the transmission information of FIG. 7, the portion K11 in the upper side in the figure includes information on the items of “title”, “id”, “link”, “author”, and “updated”, which are stored in the item “feed”. For example, characters “70” and “1” in the tag “id” included in the portion K11 indicate an org ID and a disc ID included on the optical disc 41, respectively.

The portions K12 to K14 of the transmission information each include one update information entry, and each entry includes information on the items of “title”, “link”, “id”, “published”, “updated”, and “summary” in the item “entry”.

For example, the entry included in the portion K12 is set to be update information whose title is a character string “Second Story Release” included-in the tag “title”. Furthermore, in the tag “link” of this entry, as the link destination regarding the update information, information indicating the type of the information of the link destination, and the URL of the link destination are included. In the tag “link” of the entry included in the portion K12, the URL “http://some-studio.com/est/28/1/2nd/package.xml” of the link destination is shown. In the tag “link”, a character “pack” indicating the type of the information of the link destination is included. This character “pack” indicates that information obtained by accessing the link destination is package information that is necessary to obtain additional content.

Furthermore, for example, the entry included in the portion K14 is set to be update information whose title is a character string “Guide for Sale of 28 season II” included in the tag “title”.

In the tag “link” of this entry, a character “info” indicating the type of the information of the link destination regarding the update information is included. The character “info” indicates that the information obtained by accessing the link destination in the tag “link” is a Web page of a shopping site at which content related with the recorded content recorded on the optical disc 41, for example, the content whose title is “28 season II”, can be purchased. Furthermore, in the tag “link” of the entry of the portion K14, URL “http://some-studio.com/shop/28/2/index.html” of the link destination, which is related with the update information, is shown.

In the update information distribution server 12, the update information (transmission information) shown in, for example, FIG. 7, is recorded, and the update information is updated as desired. That is, entries of new update information are sequentially added to the transmission information. When the update information distribution server 12 receives the feed URL and the access authentication information transmitted from the recording and playback device 11 and performs the authentication of the user, the update information distribution server 12 transmits the recorded update information, in more detail, the transmission information, to the recording and playback device 11.

Referring back to the description of the flowchart of FIG. 5, when the update information is transmitted in step S61, the communication unit 55 of the recording and playback device 11 receives the update information transmitted from the update information distribution server 12 in step S43. Then, the communication unit 55 supplies the received update information to the obtaining unit 63 of the controller 54.

In step S44, the obtaining unit 63 compares the update information supplied from the communication unit 55 with the update information obtained in the past, which is recorded in the recorder 53, and determines whether or not the newly obtained update information that was supplied from the communication unit 55 includes a new entry.

In a case where, for example, the obtaining unit 63 newly obtains the transmission information (update information) shown in FIG. 7 from the update information distribution server 12, and the transmission information recorded in the recorder 53 contains an entry of the portion K12 and an entry of the portion K13 of FIG. 7, the obtaining unit 63 determines that there is a new entry. That is, since the newly obtained transmission information contains an entry indicated by the portion K14, which has not been obtained thus far, it follows that new update information stored in that entry is obtained.

When it is determined in step S44 that there is no new entry, since new update information is not obtained, the processing of steps S45 to S52 is skipped, and the content updating process is completed.

On the other hand, when it is determined in step S44 that there is a new entry, in step S45, the obtaining unit 63 supplies the newly obtained update information to the recorder 53, whereby it is recorded. As the update information, the transmission information itself shown in FIG. 7 may be recorded, or only the newly obtained update information within the obtained transmission information may be recorded.

In step S46, the obtaining unit 63 determines whether or not there is an entry of package information in a new entry that is included in the update information newly obtained from the update information distribution server 12, in more detail, included in the transmission information.

For example, it is assumed that the transmission information shown in FIG. 7 is newly obtained and an entry in the portion K13 and the portion K14 within the transmission information are determined to be a new entry in step S44. In this case, in the tag “link” in the entry of the portion K13, a character “pack” indicating that the type of the information of the link destination is package information is included. Therefore, it is determined in step S46 that there is an entry of package information.

When it is determined in step S46 that there is no entry of package information, the processing of steps S47 to S52 is skipped, and the content updating process is completed.

In comparison, when it is determined in step S46 that the there is an entry of package information, in step S47, the obtaining unit 63 requests the service server 13 to transmit package information.

For example, when it is determined that the entry in the portion K13 of FIG. 7 is an entry of package information among new entries, the obtaining unit 63 transmits the URL of the link destination related with the update information in the tag “link” of the entry to the service server 13 via the communication unit 55, thereby accessing the recording destination of the information indicated by the URL.

When the recording and playback device 11 requests the service server 13 for package information, in step S71, the service server 13 transmits package information to the recording and playback device 11 in response to a request of the recording and playback device 11. That is, the service server 13 receives the URL transmitted from the recording and playback device 11 and transmits the package information specified by the URL to the recording and playback device 11 via the communication network 15.

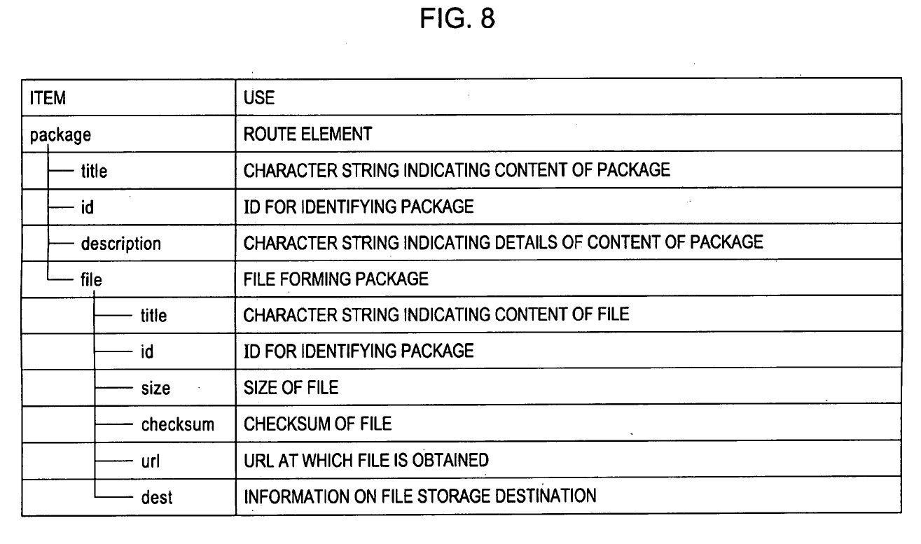

For example, when the package information recorded by the service server 13 is information described by XML (Extensible Markup Language), the package information contains information on each item shown in FIG. 8.

In FIG. 8, in the column of the left side, each item included in package information is shown, and in the column of the right side, the description of information on each item is shown. That is, the package information is provided with an item of “package”, in which other items are stored as root elements. In the item “package”, information on the items of “title”, “id”, “description”, and “file” is stored.

In the item “title”, a character string indicating the content of the package information is stored, and in the item “id”, an ID (identification information) for identifying package information is stored. The identification information stored in this item “id” has the same value as that of the ID for identifying the update information in which the package information is specified as a link destination. As a result, it is possible to identify which URL contained in the update information the package information is identified by.

Furthermore, in the item “description”, a character string indicating the details of the content of the package information is stored. Furthermore, in the item “file”, information on each item regarding a file forming the package indicated by the package information is stored.

Here, the files forming a package are assumed to be, for example, files that are necessary for playing back moving image data of additional content, or additional content. In a case where the package information contains information on a plurality of files, items “file” are stored in the item “package” in a number corresponding to the number of files.

In the item “file”, information on the items of “title”, “id”, “size”, “checksum”, “URL”, and “dest” is stored.

In the item “title” within the item “file”, a character string indicating the content of the file is stored, and in the item “id”, an ID for identifying (specifying) a file is stored. In the item “size” and the item “checksum”, the size of the file and the checksum are stored, respectively.

Furthermore, in the item “URL”, the URL of the obtaining destination of the file, that is, the recording destination in which the file is recorded, is stored. In the item “dest”, information indicating the storage destination after the file is obtained by the recording and playback device 11 is stored.

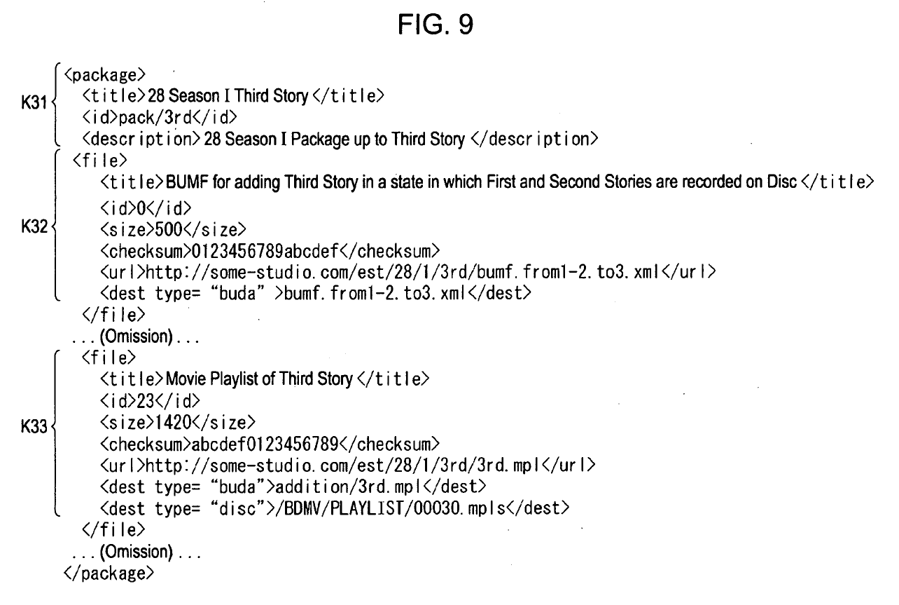

The package information in which each item shown in FIG. 8 is included is specifically set to be information shown in, for example, FIG. 9. In the portion K31 of the upper side in the package information of FIG. 9, information on the items of “title”, “id”, and “description”, which are stored in the item “package”, is included.

For example, the character “pack/3rd” in the tag “id” included in the portion K31 indicates an ID that specifies package information, which is stored in the item “id”. The character “pack/3rd” indicating this ID is set to be the same as the ID “pack/3rd” for identifying the update information in the entry of the portion K13 of FIG. 7, in which the package information of FIG. 9 is specified as a link destination.

In the portions K32 and K33 of the package information, information on each item of one file forming the package is shown correspondingly.

For example, the file indicated by the portion K32 is a file obtained by accessing the URL “http://some-studio.com/est/28/1/3rd/bumf.from1-2.to3.xml” included in the tag “URL”. The storage destination of the file is set at a position in the recorder 53, which is indicated by the character “bumf.from1-2.to3.xml” included in the tag “dest”.

In more detail, there is a case in which, in the tag “dest”, as the storage destination of the file, a path in the recorder 53 is specified and furthermore, a path in the optical disc 41 is specified. For example, in a case where, in the tag “dest”, a character indicating the storage destination of the file following a character “buda” is arranged, the character indicating the storage destination indicates the path in the recorder 53.

More specifically, the character “bumf.from1-2.to3.xml” indicating the storage destination following the character “buda” in the tag “dest” of the portion K32 indicates the path of the file to be stored and the file name. Then, the obtained file is recorded, as the file name “bumf.from1-2.to3.xml”, in the directory of the name of the value of the disc ID in the directory of the name of the value of the org ID in the meta-information of the optical disc 41, which belongs to the root directory in the recorder 53.

Furthermore, in a case where, in the tag “dest”, a character indicating the storage destination of the file is arranged following the character “disc”, the character indicating the storage destination includes only the character “buda” that specifies a path in the recorder 53 in the tag “dest” of the portion K32 indicating the path in the optical disc 41. As a consequence, the file obtained by the URL contained in the portion K32 is not recorded on the optical disc 41.

For example, the file obtained using the URL contained in the portion K32 is set to be a file called a BUMF (Binding Unit Manifest File), which is necessary for playing back the recorded content recorded on the optical disc 41, and additional content. This BUMF includes information indicating the path of the recorder 53 in which the additional content is recorded, and the like.

Furthermore, for example, the file indicated by the portion K33 is set as a file indicating a playlist of additional content. This file is a file obtained by accessing URL “http://some-studio.com/est/28/1/3rd/3rd.mpl” included in the tag “URL” of the portion K33. Then, the storage destination of the file is set to be a position in the recorder 53, which is indicated by the character “addition/3rd.mpl” included in the tag “dest”, or a position in the optical disc 41, which is indicated by the character “BDMV/PLAYLIST/00030.mpls” included in the tag “dest”.

That is, in a case where additional content is downloaded and recorded in the recorder 53, the additional content is recorded at a position indicated by the character “addition/3rd.mpl”. Furthermore, in a case where the additional content is recorded on the optical disc 41 from the recorder 53, the additional content is recorded at a position indicated by the character “BDMV/PLAYLIST/00030.mpls”.

In the service server 13, package information shown in, for example, FIG. 9, is recorded. The service server 13 receives the URL transmitted from the recording and playback device 11, and transmits the package information identified by the received URL within the recorded package information to the recording and playback device 11.

Referring back to the description of the flowchart of FIG. 5, when package information is transmitted to the recording and playback device 11 from the service server 13 in step S71, in step S48, the communication unit 55 of the recording and playback device 11 receives package information transmitted from the service server 13 and supplies it to the controller 54.

When the package information is supplied from the communication unit 55, the obtaining unit 63 of the controller 54 supplies the package information to the recorder 53, whereby it is recorded, and also causes the recorder 53 to record the status information regarding the additional content identified by the package information.

Here, the status information of the additional content refers to information indicating one of states in which the additional content has not yet been downloaded, the additional content has been downloaded and recorded in the recorder 53, and the additional content is recorded from the recorder 53 onto the optical disc 41.

The status information is set to “not yet downloaded” when the additional content has not been downloaded, is set to “downloaded” when the additional content is recorded in the recorder 53, and is set to “disc recorded” when the additional content is recorded on the optical disc 41. Therefore, the status information of the additional content identified by the package information received in step S48 is set to “not yet downloaded” at this point.

The status information is recorded in the recorder 53 in such a manner as to be related with the ID for identifying package information, for example, the ID “pack/3rd” included in the portion K31 of the package information of FIG. 9. Since this ID is also included in the update information in which the package information is specified as a link destination, the package information and the update information corresponding to the status information are identified on the basis of the ID related with the status information.

In step S49, the obtaining unit 63 accesses the recording destination of the additional content indicated by the URL contained in the package information and requests the service server 13 to transmit the additional content.

For example, the obtaining unit 63 transmits the URL contained in the tag “URL” of the portion K33 of FIG. 9 to the service server 13 via the communication unit 55, and requests for the transmission of the additional content. Furthermore, regarding a file, such as another file different from the additional content, which is indicated by the package information, for example, a BUMF, the obtaining unit 63 accesses the URL contained in the item “file” of the package information and requests the service server 13 to transmit a file.

When the recording and playback device 11 requests the service server 13 to transmit the additional content, in step S72, the service server 13 transmits the additional content to the recording and playback device 11 in response to the request of the recording and playback device 11, and the content providing process is completed.

That is, the service server 13 receives the URL transmitted from the recording and playback device 11, and transmits the additional content and the BUMF, which are identified by the received URL, to the recording and playback device 11 via the communication network 15.

When the additional content is transmitted from the service server 13 to the recording and playback device 11, in step S50, the communication unit 55 of the recording and playback device 11 receives the additional content transmitted from the service server 13 and supplies the additional content to the controller 54. When a file, such as a BUMF is transmitted from the service server 13, the communication unit 55 receives the file and supplies it to the controller 54. When additional content and the BUMF are supplied from the communication unit 55, the obtaining unit 63 of the controller 54 supplies the additional content and the BUMF to the recorder 53.

In step S51, the recorder 53 records the additional content and the file, such as a BUMF, which are supplied from the controller 54. The file of additional content or the like, which is recorded in the recorder 53, is recorded at a position indicated by the path stored in the item “dest” in the package information. Furthermore, the additional content obtained from the service server 13 has been encrypted in advance using an encryption key corresponding to a decoding key included in the AACS data on the optical disc 41.

In step S52, the obtaining unit 63 updates the status information of the additional content recorded in the recorder 53 from “not yet downloaded” to “downloaded”, and the content updating process is completed.

As described above, the recording and playback device 11 accesses the feed URL contained in the meta-information, and obtains the update information. Then, when the recording and playback device 11 knows that the additional content is uploaded to the service server 13 and has become available for viewing on the basis of the entry of the package information included in the obtained update information, the recording and playback device 11 obtains and records the additional content.

As described above, by obtaining the update information by using the feed URL that is read from the optical disc 41 and recorded, it is possible to obtain information related with the recorded content of the optical disc 41, in particular, information on content that is newly added and has become available for viewing without causing the user to perform a particular operation. Therefore, it is possible to present information related with the title of the optical disc 41 and information regarding additional content more easily and quickly.

Furthermore, in a case where an entry of package information is included in the obtained update information, the package information is obtained and additional content is obtained by using the obtained package information, making it possible to obtain additional content without causing the user to perform a particular operation. As a result, it is possible for the user to easily and quickly view the additional content without inserting the optical disc 41 into the recording and playback device 11 or without confirming the updating of the content at the Web page. This makes it possible to promote the use of content.

Furthermore, even if the user does not insert the optical disc 41 into the recording and playback device 11, information related with the content can be obtained by the recording and playback device 11. Therefore, it is possible for the provider of the content to cause the update information distribution server 12 to easily and reliably notify the user of the information on the content provided by the provider.

Furthermore, on the optical disc 41, recorded content, a feed URL, and a token serving as playback rights information indicating that the recorded content and the additional content can be played back are recorded. For this reason, it is possible for the user to purchase, collectively with ease, a plurality of cross-related content items, including additional content that has not yet been released by only purchasing one optical disc 41, that is, with one settlement.

Moreover, when additional content is sequentially released, since update information and additional content are obtained without necessitating an operation, it is possible to easily and quickly know the release of the additional content and also, the viewing of the additional content becomes possible.

In a case where each item of meta-information on a plurality of recorded content items read from each of the plurality of optical discs 41 has been recorded in the recorder 53, a content updating process described with reference to FIG. 5 is performed for each of the recorded content items. That is, a content updating process is performed at a time of access for each item of the recorded content items. The content updating process may be started immediately after the previous content updating process is completed, or may be performed at the intervals of a fixed time period.

When the additional content is recorded in the recorder 53 in the manner described above, it is possible for the user to view the additional content.

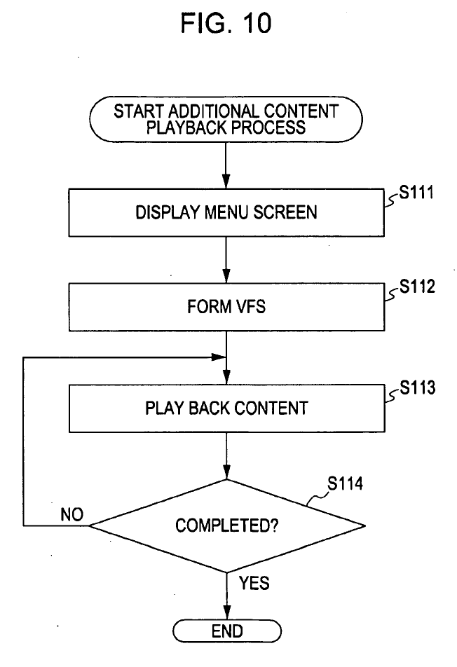

Next, a description will be given, with reference to the flowchart of FIG. 10, of an additional content playback process, in which the recording and playback device 11 plays back downloaded additional content.

In a state in which the optical disc 41 has not been inserted into the recording and playback device 11, when the user operates the input unit 52 and instructs the display of a menu screen, an operation signal in response to the operation of the user is supplied from the input unit 52 to the controller 54.

When the operation signal is supplied to the controller 54, in step S111, the controller 54 causes the display device 14 to display the menu screen on the basis of the meta-information and the update information recorded in the recorder 53.

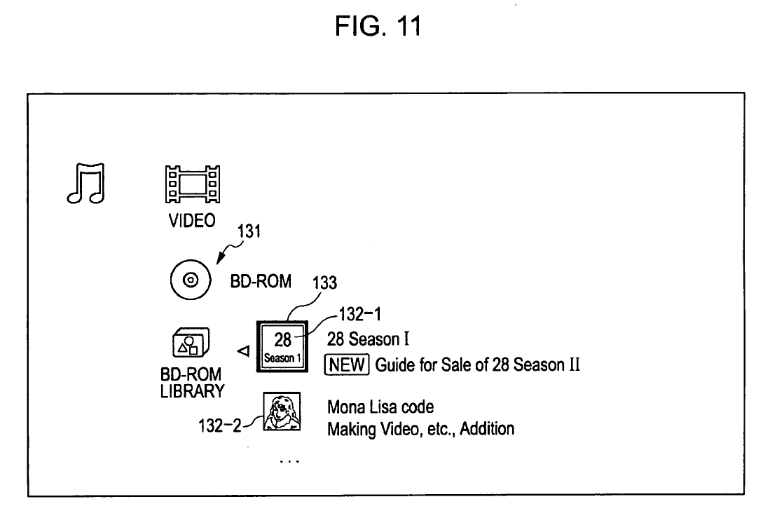

As a result, on the display device 14, for example, the menu screen shown in FIG. 11 is displayed. On the menu screen shown in FIG. 11, an item 131 for selecting content of the optical disc inserted into the recording and playback device 11, and library information formed of an image 132-1 and an image 132-2 regarding content items of the optical disc, which were played back in the past, are displayed. Furthermore, on the menu screen, a cursor 133 used to select one of the item 131 and the images 132-1 and 132-2 is also displayed.

When a predetermined optical disc 41 is inserted into the recording and playback device 11, the controller 54 causes meta-information to be read from the optical disc 41 inserted into the drive 51, and causes the titles of the content items recorded on the optical disc 41 to be displayed in the item 131 on the basis of the read meta-information. When the titles of the content items are displayed in the item 131, the user selects the item 131 by using the cursor 133, so that the content can be played back.

Furthermore, the images 132-1 and 132-2 on the menu screen are each an image indicating the content on one optical disc 41, which is displayed on the basis of the content information included in the meta-information which is read from the optical disc 41 and is recorded in the recorder 53.

On the right side of the image 132-1 in the figure, the title “28 Season I” of the content indicated by the image 132-1 is displayed. On the lower side of the title in the figure, information related with the content obtained last, that is, the title “Guide for Sale of 28 Season II” indicating the content of the update information, and a character “NEW” indicating unconfirmed update information are displayed.

The title of the content on the right side of the image 132-1 is displayed on the basis of the content information of the meta-information recorded in the recorder 53, and the title of the update information is displayed on the basis of the update information recorded in the recorder 53. For example, the character string stored in the item “title” of the update information of the portion K14 of FIG. 7, that is, the character “Guide for Sale of 28 season II” in the tag “title”, is displayed as the title of the update information on the menu screen.

Similarly to the case of the image 132-1, on the right side of the image 132-2 in the figure, the title “Mona Lisa code” of the content indicated by the image 132-2 is displayed, and on the lower side of the title in the figure, the title “Making Video, etc., Addition” indicating the content of the update information that was obtained last is displayed.

When it is not necessary to individually discriminate between the image 132-1 and the image 132-2, they will be referred to simply as an image 132.

Furthermore, the user performs an operation for the input unit 52 so as to move a cursor 133, and selects the image 132 by using the cursor 133, so that a list of the update information of the content corresponding to the image 132 can be displayed.

For example, when the image 132-1 is selected by the user and the display of the list of the update information of the content indicated by the image 132-1 is instructed, the controller 54 causes the display device 14 to display a list of the update information on the basis of the update information of the content indicated by the image 132-1 and the status information.

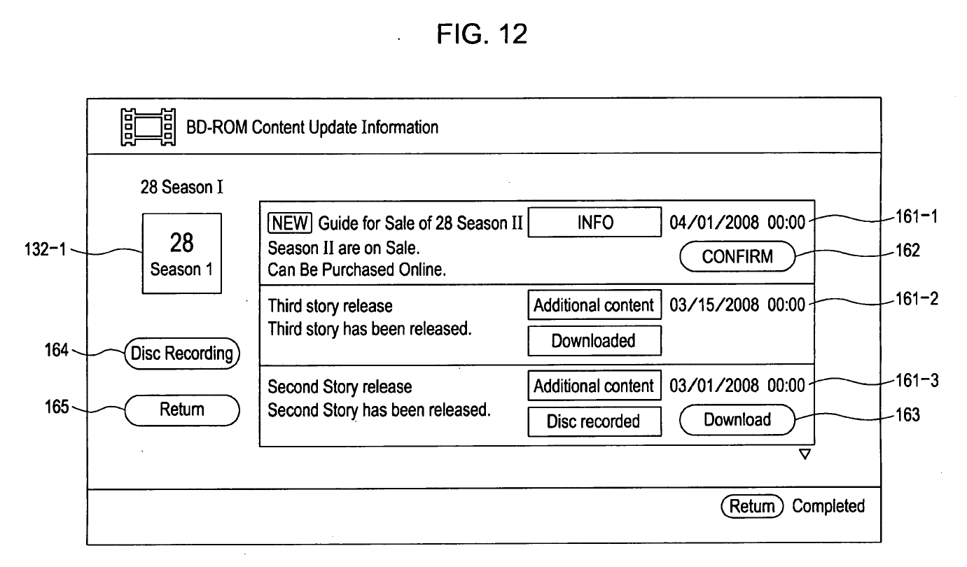

For example, when the update information of the content indicated by the image 132-1 is the update information shown in FIG. 7, the controller 54 causes the display device 14 to display a list of the update information shown in FIG. 12.

The list of the update information of FIG. 12 is provided with display columns 161-1 to 161-3 in which, together with the image 132-1, the update information (entries) of the portions K14 to K12 of FIG. 7 are displayed. For example, in the display column 161-1, the title “Guide for Sale of 28 Season II” of the update information and the content “Season II-on Sale. Can be purchased” of the update information, are displayed. These characters are a character string in the tag “title” of the portion K14 and a character string in the tag “summary” in FIG. 7.

Furthermore, in the display column 161-1, a character “INFO” indicating that the update information is information on the content related with the recorded content is displayed. The character “INFO” is displayed when the type of the information of the link destination in the tag “link” in the entry of the corresponding update information in FIG. 7, that is, the entry of the portion K14, is “info”.

Furthermore, in the display column 161-1, a button 162 that is operated when a URL in the tag “link” of the portion K14 is accessed is displayed. For example, when the button 162 is operated, on the display device 14, a Web page is displayed at which content whose title notified by the update information displayed in the display column 161-1 is “28 Season II” can be purchased.

In a case where the type of the information of the link destination in the tag “link” in the entry is “pack”, the entry is an entry that specifies package information as a link destination. Therefore, in the display column, a character “additional content” indicating update information regarding the additional content is displayed.

Furthermore, in the display column 161-1, date and time “2008/04/01 00:00” at which the update information was updated is displayed. The date and time is date and time indicated by the tag “updated” of the portion K14 of the update information in FIG. 7.

Furthermore, for example, in the display column 161-3, the title “Second Story Release” of the update information, the content “The second story has been released” of the update information, and date and time “2008/03/01 00:00” at which the update information was updated, are displayed.

In the display column 161-3, the character “Additional Content” indicating the update information regarding the additional content, and a character “disc recorded” indicating the status information of the additional content are displayed. Furthermore, in the display column 161-3, a button 163 that is operated when additional content is to be downloaded is also displayed. The button 163 is displayed in a case where the status information on the additional content is “not yet downloaded” or “disc recorded”.

When it is not necessary to individually discriminate among the display columns 161-1 to 161-3, they will be referred to simply as the display column 161. Furthermore, the update information displayed in the display column 161 is displayed in sequence starting from that of the most recent updating date and time of the update information in such a manner as to be arranged from the top to the bottom.

Furthermore, in the lower side of the image 132-1 in FIG. 12, a button 164 that is operated when additional content indicated by the update information displayed in the display column 161, in more detail, the additional content whose status information is “Downloaded” is provided. Furthermore, in the lower side of the button 164 in the figure, a button 165 that is operated when the display on the display device 14 is switched to the menu screen of FIG. 11 is provided.

As described above, by causing the display device 14 to display a list of the update information, it is possible for the user to easily and quickly know the updating state of the content without inserting the optical disc 41 into the recording and playback device 11.

Then, by confirming the status information displayed in the display column 161, it is also possible to know that new additional content has been downloaded and has become available for viewing. Accordingly, in a case where the user is to view the newly downloaded additional content, the user inserts the optical disc 41 on which the certificate and the token of the additional content have been recorded to the recording and playback device 11.

Referring back to the description of the flowchart in FIG. 10, when the optical disc 41 is inserted into the recording and playback device 11, in step S112, the playback controller 61 constructs a VFS (Virtual File System) on the basis of the BUMF recorded in the recorder 53.

Here, the VFS is a virtual file system defined by a specification for Blue-ray discs, and is a virtual file system that handles recorded content on the optical disc 41 and additional content recorded in the recorder 53 as one content.

For example, the playback controller 61 handles the recorded content and the additional content as one content by referring to a path of each content item indicated in the BUME recorded in the recorder 53, and the like.

BUMFs for forming a VFS differ depending on the status information of additional content, that is, depending on a place in which additional content is recorded. For example, in a case where a first story of a series drama is recorded content and second and third stories are additional content, in order to play back content, a different BUMF becomes necessary depending on whether the second and third stories have been recorded on the optical disc 41 or have been recorded in the recorder 53.

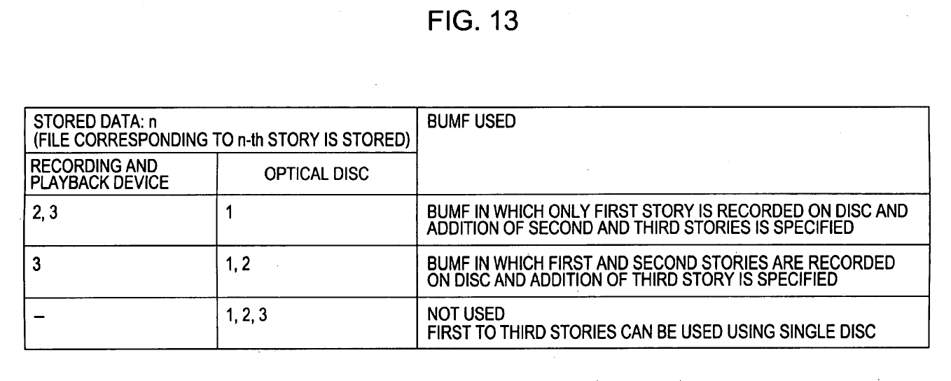

That is, as shown in FIG. 13, in a case where (the additional content of) the second and third stories has been recorded in the recorder 53, in order to construct a VFS, a BUMF in which the first story has been recorded on the optical disc 41 and addition of the second and third stories has been designated becomes necessary. In this case, a path to the second and third stories in the recorder 53 has been recorded in the BUMF.

Furthermore, in a case where the first and second stories have been recorded on the optical disc 41 and the third story has been recorded in the recorder 53, in order to construct a VFS, a BUMF in which the first and second stories have been recorded on the optical disc 41 and the addition of the third story has been designated becomes necessary. In this case, a path of the third story in the recorder 53 has been recorded in the BUMF.

Furthermore, in a case where the first to third stories have been recorded on the optical disc 41, since it is not necessary to construct a VFS, a BUMF is not used to play back the first to third stories.

In a case where the second and third stories are additional content, two types of BUMFs become necessary. Those BUMFs are obtained by accessing a URL stored in the item “file” of the package information.

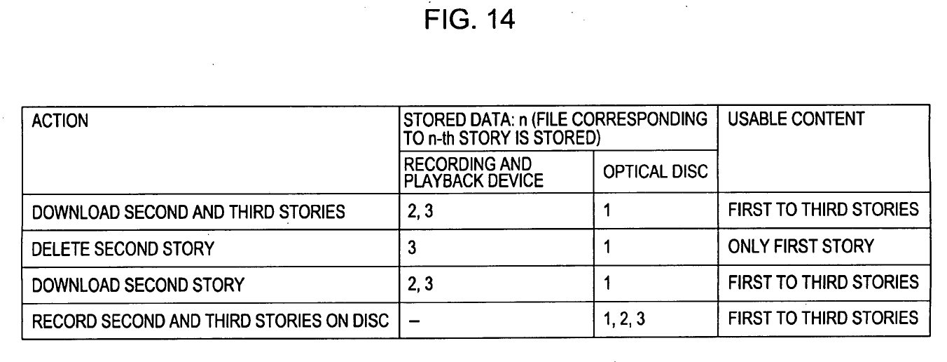

Furthermore, for example, as shown in FIG. 14, in a state in which the additional content of the second and third stories has been recorded in the recorder 53, the recording and playback device 11 constructs a VFS, making it possible to play back the content of the first to third stories.

However, if the additional content of the second story is deleted from the recorder 53, the additional content of the second story ceases to exist in the recording destination indicated by the path of the second story indicated by the BUMF. As a consequence, it is not possible for the recording and playback device 11 to construct a VFS, and only the first story recorded on the optical disc 41 can be played back.

When the additional content of the second story is deleted, since the status information of the additional content is updated to “not yet downloaded”, it becomes possible to download the second story. Thereafter, when the recording and playback device 11 downloads the second story (additional content) again, since a state in which the second story exists in the recording destination of the second story is reached, it becomes possible for the recording and playback device 11 to play back the first to third stories again.

Furthermore, when the second and third stories are recorded on the optical disc 41, it is possible to play back the first to third stories without necessitating a BUMF.

The construction may be formed in such a way that the first story has been recorded on the optical disc 41, a BUMF in which addition of the third story is designated is provided, and the recording and playback device 11 plays back the first and third stories.

Referring back to the description of the flowchart of FIG. 10, when a VFS is constructed and the user instructs the playback of the additional content, in step S113, the playback controller 61 plays back the additional content on the basis of an operation signal supplied from the input unit 52 in response to the operation of the user.

That is, the playback controller 61 refers to the path of the additional content indicated by the BUMF recorded in the recorder 53, and reads the additional content from the position of the recorder 53 indicated by the path. Furthermore, the playback controller 61 reads, via the drive 51, a certificate of additional content, random data, a media ID, a token, and AACS data from the optical disc 41.

Then, the playback controller 61 confirms whether or not the additional content to be played back is content obtained by an authorized user by using the certificate, the random data, the media ID, and the token, thereafter decodes the additional content by using the AACS data, and supplies it to the display device 14. The display device 14 displays the additional content from the playback controller 61.

In step S114, the playback controller 61 determines whether or not the playback of the additional content should be completed. For example, in a case where the user instructs that the playback of the additional content be stopped, it is determined in step S114 that the playback should be completed.

When it is determined in step S114 that the playback should not be completed, the process returns to step S113, and the above-described processing is repeated.

In comparison, when it is determined in step S114 that the playback should be completed, each unit of the recording and playback device 11 completes processing being performed, and the additional content playback process is completed.

In the manner described above, the recording and playback device 11 constructs a virtual file system by using a BUMF, and plays back the downloaded additional content.

As described above, a virtual file system is constructed, and additional content recorded in the local storage (recorder 53) of the recording and playback device 11 is played back, making it possible for the user to view and enjoy content recorded on the optical disc 41 and also content downloaded from the service server 13.

In the foregoing, it has been described that when update information is obtained, package information and additional content are obtained without necessitating the operation of the user. Alternatively, package information and additional content may be obtained in a case where an instruction is made is designated by the user who has confirmed the update information.

In such a case, after the user confirms the list of the update information displayed on the display device 14, the user inserts the optical disc 41 corresponding to the additional content to be obtained into the recording and playback device 11, and instructs that the package information and the additional content be obtained. Then, the obtaining unit 63 of the recording and playback device 11 reads and executes, for example, a program of BD-J (BD (Blu-ray Disc (registered trademark of Sony Corporation))-Java (registered trademark)) from the optical disc 41 via the drive 51, and the package information and the additional content are obtained from the service server 13 by using the update information.

The recording and playback device 11 is designed in such a manner that, in order to prevent the shortage of the recording area of the recorder 53, which occurs as a result of many items of additional content being recorded in the recorder 53, the additional content recorded in the recorder 53 can be recorded on the optical disc 41.

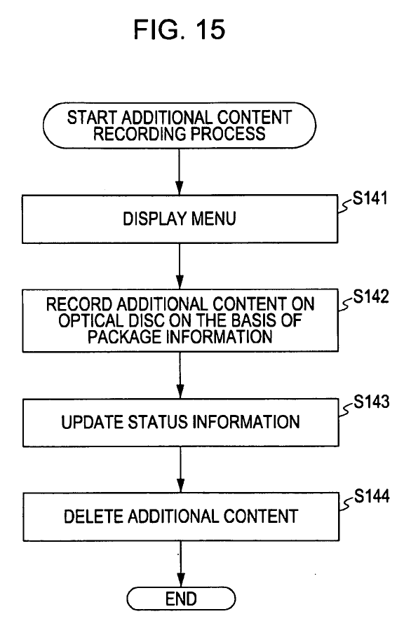

A description will be given below, with reference to the flowchart of FIG. 15, of an additional content recording process performed by the recording and playback device 11.

In a state in which the optical disc 41 has not been inserted into the recording and playback device 11, when the user operates the input unit 52 so as to instruct the display of the menu screen, an operation signal in response to the operation of the user is supplied from the input unit 52 to the controller 54.

When the operation signal is supplied to the controller 54, in step S141, the controller 54 causes the display device 14 to display, for example, the menu screen of FIG. 11 on the basis of the meta-information and the update information recorded in the recorder 53.

After the menu screen is displayed, when the user further performs an operation on the input unit 52 in order to display a list of the update information of FIG. 12, and operates the button 164, the controller 54, in response to the operation of the user, causes the display device 14 to display a message prompting the insertion of the optical disc 41.

Then, when the user inserts the optical disc 41 into the recording and playback device 11 in response to the message, in step S142, the recording controller 62 causes the additional content to be recorded on the optical disc 41 on the basis of the package information recorded in the recorder 53.

That is, the recording controller 62 obtains the specified additional content from the recorder 53 and supplies it to the drive 51. Then, the recording controller 62 reads the path of the recording destination of the additional content specified in the item “dest” in the item “file” corresponding to the additional content to be recorded in the package information recorded in the recorder 53.

This path is, for example, a path “BDMV/PLAYLIST/0030.mpls” specified in the tag among two tags “dest” of the portion K33 of FIG. 9, in which a character “disc” that specifies a path on the optical disc 41 is included.

When the recording controller 62 reads the path indicating the recording destination of the additional content, the recording controller 62 controls the drive 51 so that the supplied additional content is recorded at a position of the optical disc 41, which is indicated by the read path. In accordance with the instructions from the recording controller 62, the drive 51 records the additional content supplied from the recording controller 62 on the optical disc 41.

On the optical disc 41, the certificate, the token, and the AACS data, which are used in common with other content, which are necessary to play back the additional content, have been recorded in advance. As a consequence, it becomes possible for the user to view the additional content recorded on the optical disc 41 by inserting the optical disc 41 into the recording and playback device 11.

In step S143, the obtaining unit 63 updates the status information of the additional content recorded on the optical disc 41 from “downloaded” to “disc recorded”.

In step S144, the recording controller 62 deletes the additional content recorded on the optical disc 41 from the recorder 53, and the additional content recording process is completed. That is, the recorder 53 deletes the recorded additional content in accordance with the instructions from the recording controller 62.

In the manner described above, the recording and playback device 11 records the additional content recorded in the recorder 53 on the optical disc 41.

As described above, by recording the additional content recorded in the recorder 53 on the optical disc 41 and by deleting the recorded additional content from the recorder 53, it is possible to prevent the recording area of the recorder 53 from becoming insufficient. Furthermore, it is possible for the user to view the recorded additional content and the pre-recorded content by using the single optical disc 41.

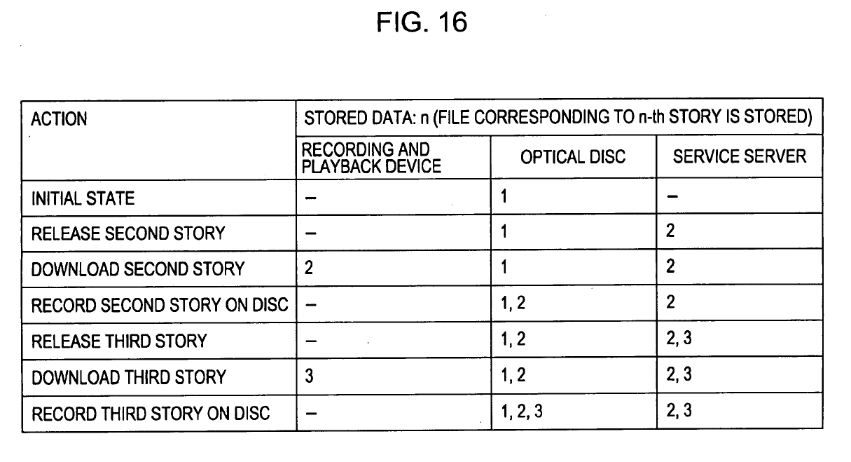

As described above, according to the recording and playback device 11, it is possible to download additional content that is purchased in advance by the user and record it on the optical disc 41. As forms of use of the optical disc 41 on which pre-purchased additional content can be additionally recorded, for example, forms shown in FIG. 16 to FIG. 18 are possible.

In the forms of use shown in FIGS. 16 to 18, it is assumed that the user purchases the optical disc 41 on which (the moving image data of) the first story has been recorded in advance and (the moving image data of) the second and third stories can be additionally recorded within the content of a series drama formed of the first to third stories. That is, the first story is assumed to be recorded content, and the second and third stories are assumed to be additional content.

In the form of use shown in FIG. 16, the user purchases the optical disc 41 on which the first story has been recorded. Then, when the second story is released and uploaded to the service server 13, the recording and playback device 11 obtains the second story from the service server 13. At this point, the first story has been recorded on the optical disc 41, and the second story has been recorded in the recording and playback device 11.

Furthermore, when the recording and playback device 11 records the second story on the optical disc 41 in accordance with the instructions of the user, a state is reached in which the first and second stories has been recorded on the optical disc 41 and nothing has been recorded in the recording and playback device 11.

Thereafter, when the third story is released and uploaded to the service server 13, the recording and playback device 11 obtains the third story from the service server 13. Then, a state is reached in which the first and second stories have been recorded on the optical disc 41 and the third story has been recorded in the recording and playback device 11. When the recording and playback device 11 records the third story on the optical disc 41 in accordance with the instructions from the user, a state is reached in which the first to third stories have been recorded on the optical disc 41 and nothing has been recorded in the recording and playback device 11. As a result, in the end, the optical disc 41 becomes in the same state as the optical disc on which the content of the first to third stories has been recorded in advance and sold.

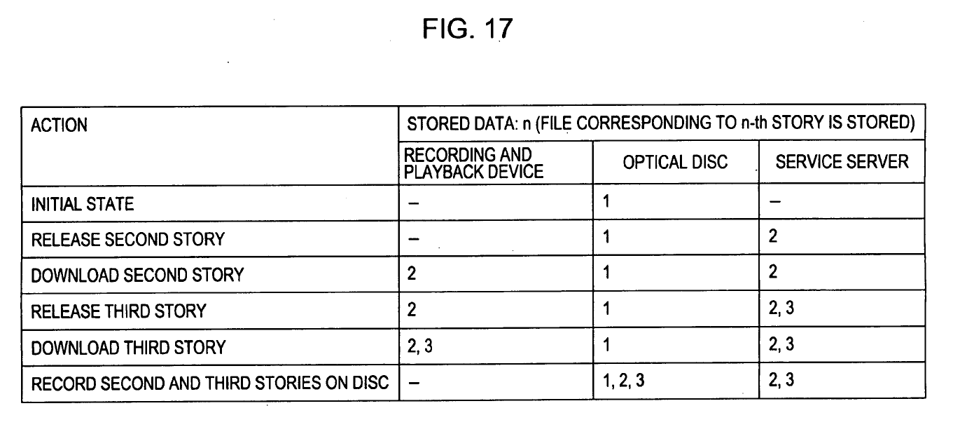

Furthermore, in the form of use shown in FIG. 17, the user purchases the optical disc 41 on which the first story has been recorded. Then, when the second story is released and uploaded to the service server 13, the recording and playback device 11 obtains the second story from the service server 13. At this point, the first story has been recorded on the optical disc 41, and the second story has been recorded in the recording and playback device 11.

Thereafter, when the third story is released and uploaded to the service server 13, the recording and playback device 11 obtains the third story from the service server 13. Then, a state is reached in which the first story has been recorded on the optical disc 41, and the second and third stories have been recorded in the recording and playback device 11.

Then, when the recording and playback device 11 records the second and third stories on the optical disc 41 in accordance with the instructions from the user, a state is reached in which the first to third stories have been recorded on the optical disc 41, and nothing has been recorded in the recording and playback device 11. As a result, in the end, the optical disc 41 becomes in the same state as the optical disc on which the first to third stories have been recorded in advance and sold.

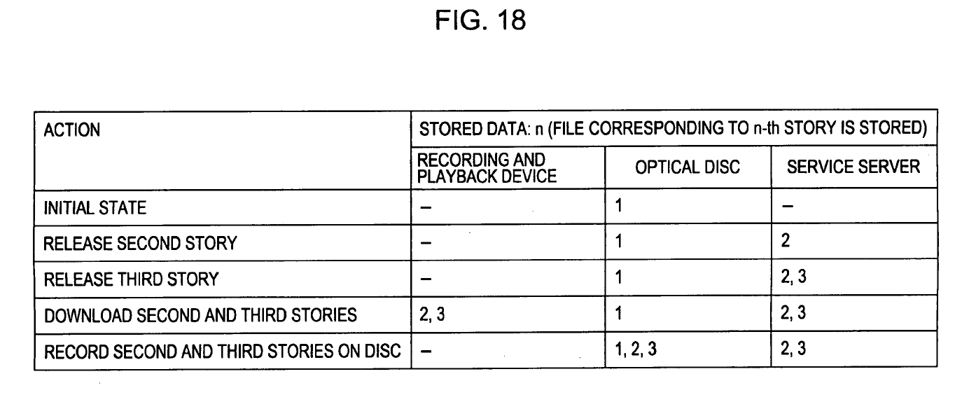

Furthermore, in the form of use shown in FIG. 18, the user purchases the optical disc 41 on which the first story has been recorded. Then, when the second story is released and uploaded to the service server 13, and the third story is released and uploaded to the service server 13, a state is reached in which the second and third stories have been recorded in the service server 13.

Then, when the recording and playback device 11 obtains the second and third stories from the service server 13, a state is reached in which the first story has been recorded on the optical disc 41, and the second and third stories have been recorded in the recording and playback device 11.

Thereafter, when the recording and playback device 11 records the second and third stories on the optical disc 41 in accordance with the instructions from the user, a state is reached in which the first to third stories have been recorded on the optical disc 41, and nothing has been recorded in the recording and playback device 11. As a result, in the end, the optical disc 41 becomes in the same state as the optical disc on which content of the first to third stories has been recorded in advance and sold.

As described above, the user purchases the optical disc 41 on which some of a plurality of cross-related content items have been recorded in advance, downloads the remaining content items from the service server 13, and records the content items on the optical disc 41, making it possible for the user to enjoy a plurality of content items with one settlement. Furthermore, it is possible for the provider of the content items to perform early collection of investment money, such as investment money for content that has not yet been released, in a preceding manner.

For example, in a case where the user purchases the content from the first to fifth stories of a series drama and records additional content among the first to fifth stories on the optical disc 41, the construction may be formed in such a way that when a pack of content from the sixth to tenth stories is newly sold, the user can download the content of the sixth to tenth stories from the service server 13.

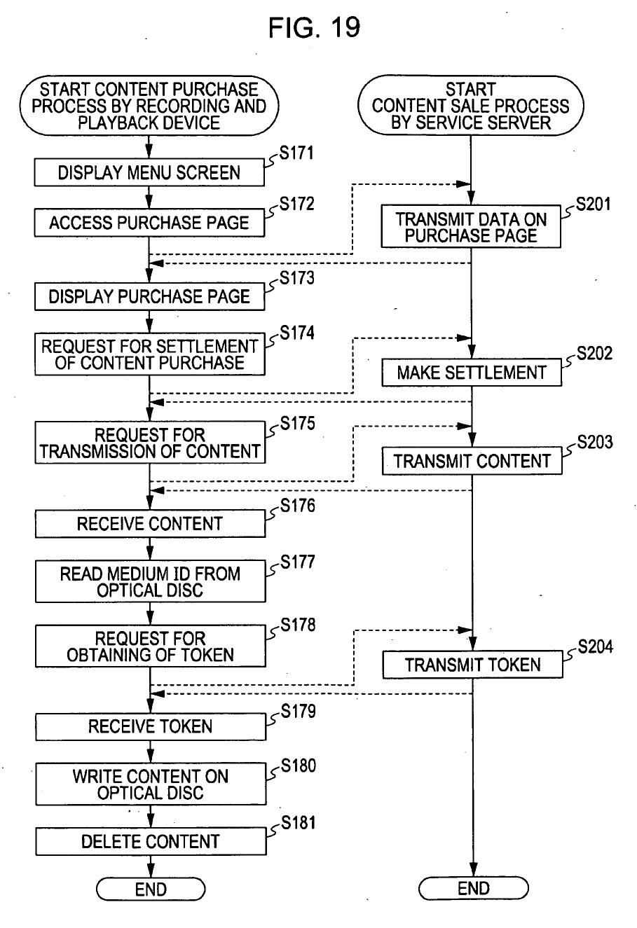

A description will be given below, with reference to the flowchart of FIG. 19, of a content purchase process and a content sale process performed in the above-described case by the recording and playback device 11 and the service server 13.

In a state in which the optical disc 41 has not been inserted into the recording and playback device 11, when the user operates the input unit 52 so as to instruct the display of the menu screen, an operation signal in response to the operation of the user is supplied from the input unit 52 to the controller 54.

When the operation signal is supplied to the controller 54, in step S171, the controller 54 causes the display device 14 to display, for example, the menu screen shown in FIG. 11 on the basis of the meta-information and the update information recorded in the recorder 53.

It is assumed that the menu screen is displayed and the user further performs an operation on the input unit 52 so as to display a list of the update information of FIG. 12. In the list of the update information of FIG. 12, update information stating that other content related with the content that has already been purchased by the user is newly sold is displayed in the display column 161-1. The user operates the button 162 so as to access a purchase page of the content whose title is “28 season II”, which is shown in the display column 161-1, making it possible for the user to purchase the content “28 season II” related with the content of the optical disc 41.

When the user operates the button 162, an operation signal in response to the operation of the user is supplied from the input unit 52 to the controller 54.

In step S172, the recording and playback device 11 accesses the purchase page of the related content. That is, the controller 54 reads the URL stored in the item “link” within the update information displayed in the display column 161-1 within the update information recorded in the recorder 53. For example, the URL in the tag “link” of the entry of the portion K14 of FIG. 7 is read.

Then, the controller 54 causes the communication unit 55 to transmit the read URL to the service server 13, and requests the service server 13 to transmit data for displaying a purchase page (Web page) recorded at a position indicated by the URL.

When the URL of the purchase page is transmitted from the recording and playback device 11, in step S201, the service server 13 receives the transmitted URL. Then, the service server 13 transmits the data of the purchase page recorded at the position indicated by the received URL to the recording and playback device 11 via the communication network 15.

The communication unit 55 receives the data of the purchase page transmitted from the service server 13, and supplies the data to the controller 54. Then, in step S173, the controller 54 supplies the supplied from the communication unit 55 to the display device 14, whereby the purchase page is displayed.

When the purchase page is displayed on the display device 14, the user inputs the user ID for identifying the user registered in advance in the service server 13 and also instructs the purchase of the content by specifying content to be purchased. Then, the input user ID and the operation signal indicating the specified content are supplied to the controller 54 from the input unit 52.

In step S174, the controller 54 requests the service server 13 to make a content purchase settlement. That is, the controller 54 obtains a product ID for identifying the specified content from the image data for displaying a purchase page on the basis of the information indicating content supplied from the input unit 52. Then, the controller 54 supplies, to the communication unit 55, a purchase request signal including the user ID and the product ID and informing the request of a settlement, and the communication unit 55 transmits the purchase request signal from the controller 54 to the service server 13.

Then, in step S202, the service server 13 receives the purchase request signal transmitted from the recording and playback device 11 and makes a settlement. That is, the service server 13 confirms that the user who requests for the purchase of a product is a pre-registered authorized user on the basis of the user ID contained in the received purchase request signal, and makes a settlement of the content identified by the product ID contained in the purchase request signal. At this time, the service server 13 records necessary information, such as the user ID and the product ID.

Then, when the settlement of the purchase of the content identified by the requested product ID is completed, the service server 13 transmits a report informing that the settlement has been completed to the recording and playback device 11. Then, the communication unit 55 of the recording and playback device 11 receives the report transmitted from the service server 13 and supplies it to the controller 54, and the controller 54 supplies the report supplied from the communication unit 55 to the display device 14, whereby the report is displayed. As a result, on the display device 14, the report informing that the settlement of the purchase of the content has been completed is displayed.

Then, when the user performs an operation on the input unit 52 and instructs the downloading of the purchased content, an operation signal instructing the downloading of content is supplied from the input unit 52 to the controller 54.

In step S175, the obtaining unit 63 of the controller 54 requests the service server 13 to transmit content in response to the operation signal from the input unit 52. That is, the obtaining unit 63 supplies, to the communication unit 55, a transmission request signal for requesting for the transmission of content, in which the user ID input at the time of the purchase of the content, and the identified product ID are contained. Then, the communication unit 55 transmits the transmission request signal from the controller 54 to the service server 13.

Here, it is assumed that the content purchased by the user is, for example, moving image data from the sixth to tenth stories of a series drama, only the sixth story has been released and has become available for viewing at the current time, and the remaining seventh to tenth stories are not available for viewing.

When the transmission request signal is transmitted from the recording and playback device 11 to the service server 13, in step S203, the service server 13 receives the transmitted transmission request signal and transmits the requested content to the recording and playback device 11. That is, the service server 13 identifies content that should be transmitted to the recording and playback device 11 on the basis of the user ID and the product ID contained in the received transmission request signal.

For example, the service server 13 has recorded therein, for each user identified by the user ID, information indicating the content purchased by the user, and information indicating the content provided to the user, that is, information indicating the content transmitted to the recording and playback device 11. The service server 13 identifies content that should be transmitted on the basis of the user ID and the product ID. For example, when the user purchases content from the sixth to tenth stories of a series drama, the content of the sixth story is identified as content that should be transmitted.

When the content that should be transmitted is identified, the service server 13 transmits the identified content to the recording and playback device 11. In more detail, the service server 13 also transmits, together with the content, a certificate and AACS data, which are common to all the content purchased by the user. Therefore, for example, the content of the sixth story, a certificate common to the sixth to tenth stories, and the AACS data used in common to the sixth to tenth stories, are transmitted to the recording and playback device 11.

Here, the content to be transmitted has been encrypted using an encryption key corresponding to a decoding key included in the AACS data, and content information, a feed URL, access frequency information, and access authentication information have been attached as meta-information to the content.

When the content is transmitted from the service server 13 to the recording and playback device 11, in step S176, the communication unit 55 of the recording and playback device 11 receives the content transmitted from the service server 13, in more detail, the content, the certificate, and the AACS data. Then, the communication unit 55 supplies the received content to the controller 54. As a result, it follows that, on the basis of the predetermined update information of the content, other content related with the content is obtained from the service server 13 indicated by the update information.

The obtaining unit 63 of the controller 54 supplies the content, the certificate, and the AACS data supplied from the communication unit 55 to the recorder 53, whereby they are recorded. Furthermore, the controller 54 causes the display device 14 to display a message prompting the insertion of an optical disc. The user seeing the message inserts, into the recording and playback device 11, the optical disc 41 on which nothing has been recorded, that is, a so-called blank disc, which differs from the optical disc 41 on which the first to fifth stories have been recorded.

When the optical disc 41 on which nothing has been recorded is inserted into the recording and playback device 11, the controller 54 instructs the drive 51 to read the media ID from the optical disc 41. The media ID is identification information unique to the optical disc 41 and is recorded on the optical disc 41 in advance. Furthermore, the recording controller 62 of the controller 54 instructs the drive 51 to generate a predetermined random number and to write the random number as random data to the optical disc 41.

In step S177, in accordance with the instructions from the controller 54, the drive 51 reads the media ID from the optical disc 41 and supplies it to the controller 54 and also records the random data supplied from the controller 54 at a predetermined position of the optical disc 41.

In step S178, the obtaining unit 63 of the controller 54 requests for the obtaining of a token that is necessary to play back the content purchased by the user. That is, the obtaining unit 63 supplies the user ID, the product ID, the media ID read from the optical disc 41, and an obtaining request signal including the generated random data to the communication unit 55. Then, the communication unit 55 transmits the obtaining request signal from the obtaining unit 63 to the service server 13.

Then, in step S204, the service server 13 receives the obtaining request signal transmitted from the recording and playback device 11 and transmits a token to the recording and playback device 11 in response to the request of the recording and playback device 11.

That is, the service server 13 generates a token that is necessary when the content purchased by the user is to be reproduced by using the media ID and the random data that are included in the received obtaining request signal and the pre-recorded predetermined data. At this time, a token for content identified by the user ID and the product ID is generated. Then, the service server 13 transmits the generated token to the recording and playback device 11, and the content sale process is completed. Here, the generated token is used in common when the content from the sixth to tenth stories is to be played back.

When the token is transmitted from the service server 13 to the recording and playback device 11, in step S179, the communication unit 55 of the recording and playback device 11 receives the token transmitted from the service server 13. Then, the communication unit 55 supplies the received token to the controller 54, and the obtaining unit 63 of the controller 54 supplies the token from the communication unit 55 to the recorder 53, whereby it is recorded.

Then, the recording controller 62 reads the content, the certificate, the AACS data, and the token, which have been received and recorded, from the recorder 53, supplies them to the drive 51, and instructs the drive 51 to write the content and the like to the optical disc 41.

In step S180, in accordance with the instructions from the recording controller 62, the drive 51 writes the content, the certificate, the AACS data, and the token, which have been supplied from the recording controller 62 to the inserted optical disc 41.

When the content is recorded on the optical disc 41, in step S181, the recording controller 62 deletes, from the recorder 53, the content, the certificate, the AACS data, and the token recorded on the optical disc 41, and the content purchase process is completed.

As a result, a state is reached in which, on the optical disc 41, the content of the sixth story within the content of the sixth to tenth stories, which is purchased by the user, and the certificate, the AACS data, and the token, which are necessary to play back the sixth to tenth stories have been recorded. Therefore, when the seventh to tenth stories are sequentially released, it becomes possible for the user to download the content as additional content to the recording and playback device 11 and view it, and to write the content on the optical disc 41. In such a case, the playback process, the content updating process, the additional content playback process, and the additional content recording process are performed as appropriate by the recording and playback device 11.

As described above, in accordance with the instructions from the user, the recording and playback device 11 requests the service server 13 to make a settlement of the purchase of new content, downloads the content, and records the content on the optical disc 41.

As described above, by requesting for a settlement, downloading content, and recording it on the optical disc 41, it is possible for the user to obtain, with a simple operation, the optical disc 41 on which the purchased content has been recorded. Moreover, the user only confirms the update information of the viewed content, operates a button provided in the list of the update information, for example, the button 162 of FIG. 12, and inputs necessary information, such as the user ID, making it possible to easily purchase content related with the content owned by the user.

It has been described in the foregoing that, when the settlement of the purchase of the content is completed, content corresponding to the recorded content is downloaded and recorded on the optical disc 41. However, the recording of the content onto the optical disc 41 may not be performed immediately after the settlement. That is, for example, when, after the settlement, an instructions from the user occurs, the content may be downloaded and recorded on the optical disc 41.

After the settlement of the purchase of the content, the user may receive the optical disc 41 on which content has been recorded at a specific shop. Alternatively, the user may directly purchase the optical disc 41 at a shop without making a settlement of the purchase.

Furthermore, it has been described in the foregoing that, in a case where the recording and playback device 11 obtains update information from the update information distribution server 12, only the newly obtained update information within the obtained update information is recorded. Alternatively, the update information distribution server 12 may transmit only the necessary update information to the recording and playback device 11.

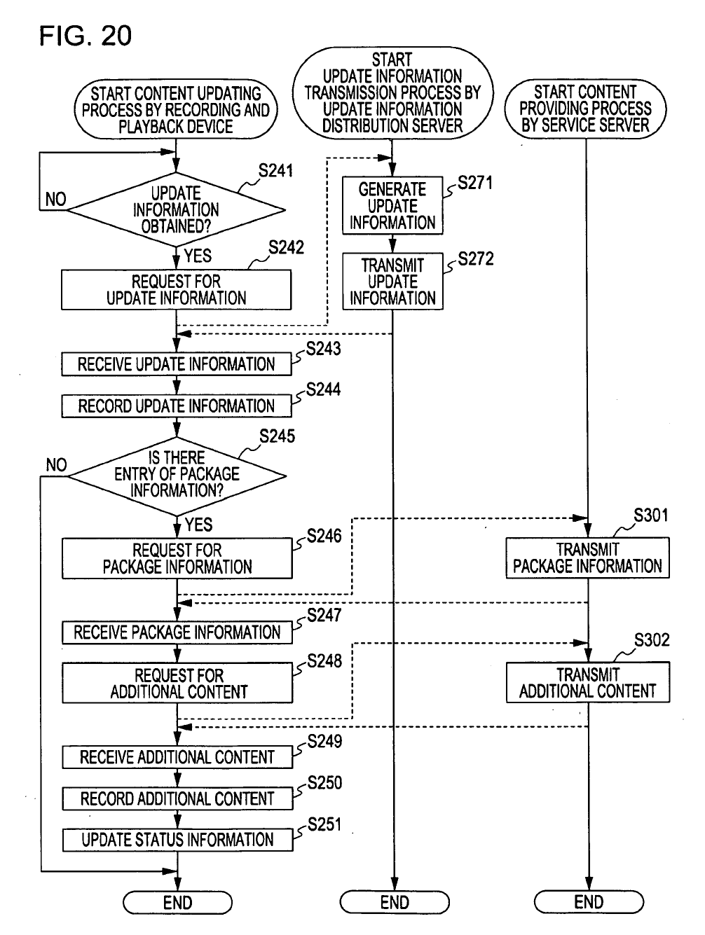

In such a case, the recording and playback device 11 and the update information distribution server 12 perform, for example, processing shown in FIG. 20. FIG. 20 is a flowchart illustrating a content updating process, an update information transmission process, and a content providing process, which are performed by the recording and playback device 11, the update information distribution server 12, and the service server 13, respectively.

In step S241, the obtaining unit 63 of the recording and playback device 11 determines whether or not update information should be obtained on the basis of the access frequency information included in the meta-information on the recorded content recorded in the recorder 53.

When it is determined in step S241 that the update information should not be obtained, the process returns to step S241, and the determination process is repeated until it is determined that the update information should be obtained.

In comparison, when it is determined in step S241 that the update information should be obtained, in step S242, the obtaining unit 63 requests the update information distribution server 12 to transmit the update information.

That is, the obtaining unit 63 reads the feed URL and the access authentication information included in the meta-information from the recorder 53. Then, the obtaining unit 63 transmits the read feed URL and access authentication information and a list of the obtained update information to the update information distribution server 12 via the communication unit 55, thereby requesting for the transmission of the update information.

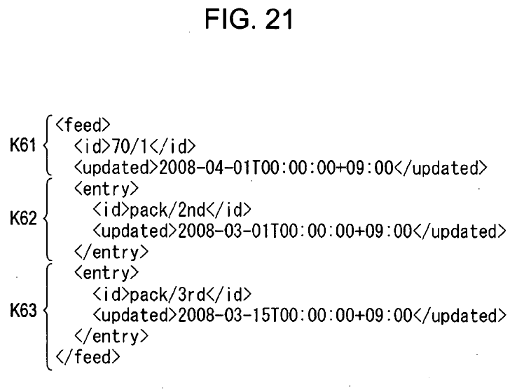

At this point, in the list of the obtained update information, as shown in, for example, FIG. 21, the last obtained update information, in more detail, the ID and the updating date and time, which are stored in the item “id” and the item “updated” in the item “feed” of the transmission information, and the ID and the updating date and time, which are stored in the item “id” and the item “updated” in the item “entry” with regard to each entry included in the transmission information, are included.

In the example of FIG. 21, a portion K61 of the list of the update information includes information stored in the item “id” and the item “updated” within the item “feed” of the transmission information. That is, the portion K61 includes information included in the tag “id” and the tag “updated” of the portion K11 of FIG. 7.

Furthermore, each of the portion K62 and the portion K63 of FIG. 21 includes information on entries of the transmission information. That is, the portion K62 includes information included in the tag “id” and the tag “updated” in the K12 of FIG. 7, and the portion K63 includes information included in the tag “id” and the tag “updated” in the portion K13 of FIG. 7.

As described above, a list of the update information transmitted to the update information distribution server 12 includes information for identifying the transmission information that is received last, and information for identifying the received entry (update information). For this reason, it is possible for the update information distribution server 12 receiving the list of the update information to know which update information has been recorded in the recording and playback device 11 that has requested for the update information.

Referring back to the description of the flowchart of FIG. 20, when the feed URL, the access authentication information, and the list of the update information are transmitted from the recording and playback device 11 to the update information distribution server 12, and a request for the transmission of the update information, in step S271, the update information distribution server 12 generates update information is made.

That is, the update information distribution server 12 receives the feed URL, the access authentication information, and the list of the update information, which are transmitted from the recording and playback device 11, and performs an authentication of whether or not the user is a pre-registered authorized user by using the access authentication information. Then, when the authentication is performed, the update information distribution server 12 generates transmission information in which all the update information, excluding the update information indicated by the list of the received update information within the update information identified by the received feed URL, is included. As a result, transmission information in which entries of the update information that has not yet been obtained by the recording and playback device 11 are included is generated.

In step S272, the update information distribution server 12 transmits the update information, in more detail, the generated transmission information, to the recording and playback device 11, and thus the update information transmission process is completed.

In step S243, the communication unit 55 of the recording and playback device 11 receives the update information transmitted from the update information distribution server 12, that is, the transmission information. Then, the communication unit 55 supplies the received update information to the obtaining unit 63 of the controller 54.

When the update information (transmission information) is supplied from the communication unit 55, the obtaining unit 63 supplies the supplied update information to the recorder 53.

In step S244, the recorder 53 records the update information supplied from the obtaining unit 63. As a result, in the recorder 53, the update information that has not been obtained thus far is newly recorded. Thereafter, the processes of steps S245 to S251 are performed. Those processes are identical to those processes of steps S46 to S52 of FIG. 5, and accordingly, the descriptions thereof are omitted.

Furthermore, the service server 13 performs the process of step S301 and the process of step S302. Since these processes are also identical to the process of step S71 and the process of step S72 of FIG. 5, the descriptions thereof are omitted.

In the manner described above, the recording and playback device 11 transmits a list of the obtained update information and requests for the transmission of the list, thereby newly obtaining only the update information that has not yet been obtained, and records it. As described above, by transmitting the list of the update information, it is possible to prevent the already obtained update information from being obtained in a duplicated manner.

It has been described that a list of update information is transmitted when the update information is to be obtained. Alternatively, the update information may not be transmitted, and the update information distribution server 12 may manage which update information has been obtained for each recording and playback device 11.

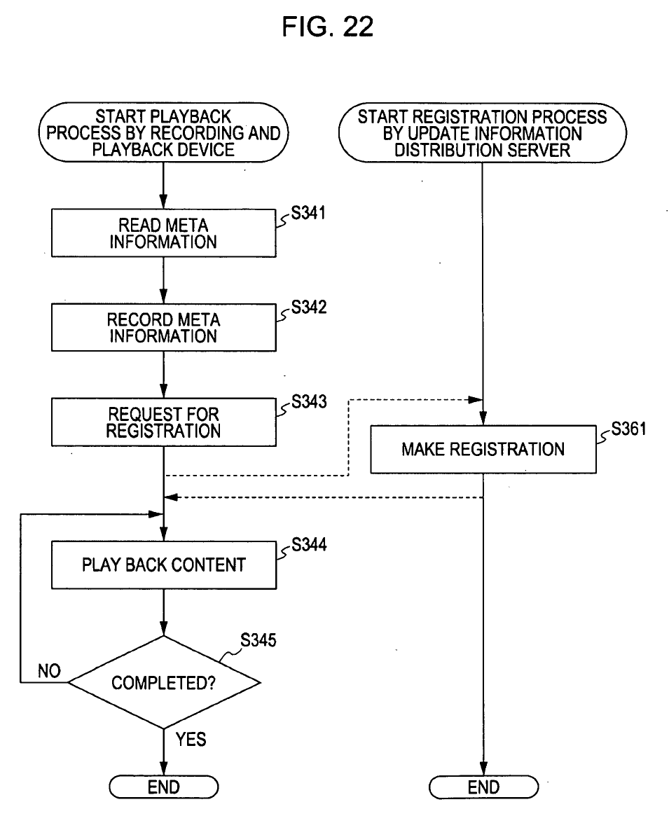

In such a case, for example, a playback process and a registration process, which are shown in the flowchart of FIG. 22, are performed by the recording and playback device 11 and the update information distribution server 12, respectively, and the registration of the user, in more detail, the recording and playback device 11, is performed. The process of step S341 and the process of step S342 are identical to process of step S11 and the process of step S12 of FIG. 4, and accordingly, the descriptions thereof are omitted.

That is, when the optical disc 41 that has not yet been played back thus far is inserted into the recording and playback device 11, the recording and playback device 11 reads meta-information from the inserted optical disc 41 and records the meta-information in the recorder 53.

When the meta-information is recorded, in step S343, the controller 54 requests the update information distribution server 12 to register the recording and playback device 11 (user) via the communication unit 55. That is, the controller 54 supplies, to the communication unit 55, information for identifying the content of the optical disc 41 and the information for identifying the recording and playback device 11, more specifically, the org ID and the disc ID contained in the meta-information and the device ID of the recording and playback device 11. Then, the communication unit 55 transmits the org ID, the disc ID, and the device ID, which are supplied from the controller 54, to the update information distribution server 12, and requests for the registration of the recording and playback device 11.

Here, the device ID is information recorded in the recording and playback device 11 in advance and information for identifying the recording and playback device 11. The update information distribution server 12 that is the request source of the registration of the recording and playback device 11, that is, the access destination, may be set as a URL contained in the meta-information, or may be set as a URL recorded in the recorder 53 and the optical disc 41 in advance.

When an org ID, a disc ID, and a device ID are transmitted from the recording and playback device 11 to the update information distribution server 12, in step S361, the update information distribution server 12 receives the transmitted org ID, disc ID, and device ID, and performs the registration of the recording and playback device 11.

That is, the update information distribution server 12 records the received org ID, disc ID, and device ID. Furthermore, after that, each time update information is transmitted to the recording and playback device 11 identified by the device ID, the update information distribution server 12 records a list of the update information transmitted to the recording and playback device 11 with regard to the content identified by the org ID and the disc ID. Then, when a request for the transmission of the update information is made, the update information distribution server 12 refers to the list of the recorded update information, and generates update information that should be transmitted to the recording and playback device 11.

In the manner described above, when the registration of the recording and playback device 11 is performed in the update information distribution server 12, the update information distribution server 12 transmits a report informing that the registration has been completed to the recording and playback device 11, and thus the registration process is completed. In the update information distribution server 12, content may be identified on the basis of the information obtained by simply arranging the org ID and the disc ID. Alternatively, a value specific to each content may be calculated by computations using the org ID and the disc ID, and content may be identified.

Furthermore, the communication unit 55 of the recording and playback device 11 receives a report informing that the registration has been completed, which has been transmitted from the update information distribution server 12, and supplies it to the controller 54. The controller 54 supplies the report supplied from the communication unit 55 to the display device 14, whereby the report informing that the registration has been completed is displayed on the display device 14.

Furthermore, the controller 54 causes the recorder 53 to record a registration flag informing that user registration (device registration of the recording and playback device 11) has been made, that is, the set registration flag, in such a manner as to be related with the meta-information. This registration flag is a flag indicating whether or not a process for obtaining update information should be performed. In a case where the registration flag has been reset, even if a time is reached at which the update information should be obtained in accordance with the access frequency information, the update information is not obtained.

After the registration flag is recorded in the recorder 53, the process of step S344 and the process of step S345 are performed, and thus the playback process is completed. Since these processes are identical to the process of the step S13 and the process of step S14 in FIG. 4, the descriptions thereof are omitted.

In the manner described above, the recording and playback device 11 transmits the org ID, the disc ID, and the device ID to the update information distribution server 12 in order to request for the registration of the recording and playback device 11. In response to the request by the recording and playback device 11, the update information distribution server 12 performs the registration of the recording and playback device 11.

In the manner described above, by performing the registration of the recording and playback device 11 in advance, it is possible for the recording and playback device 11 to easily obtain only the necessary update information.

When the registration of the recording and playback device 11 is performed in the update information distribution server 12, in order to obtain the update information on the content of the optical disc 41, processes identical to the content updating process, the update information transmission process, and the content providing process, which are described with reference to the flowchart in FIG. 20, are performed.

However, in a case where the registration flag recorded in association with the meta-information on the content for which update information is obtained has been reset, the content updating process is not performed.

Furthermore, in the process of step S242, the communication unit 55 transmits the org ID, the disc ID, and the device ID to the update information distribution server 12, and requests for the transmission of the update information.

Furthermore, when the update information distribution server 12 receives the transmitted org ID, disc ID, and device ID, the update information distribution server 12 performs an authentication of whether the recording and playback device 11 is a registered on the basis of the device ID. Thereafter, the update information distribution server 12 generates transmission information formed of update information that should be transmitted to the recording and playback device 11 on the basis of the org ID, the disc ID, the device ID, and the list of the recorded update information. That is, transmission information including only the update information that has not yet been transmitted is generated and transmitted to the recording and playback device 11.

In the manner described above, when the registration of the recording and playback device 11 is performed in the update information distribution server 12, it is possible for the update information distribution server 12 to know which update information has been transmitted to each recording and playback device 11. The update information includes, for example, information informing the sale of new content related with the content owned by user, and the like. Since the recording and playback device 11 obtains the update information from the update information distribution server 12 and displays the update information without necessitating an instructions from the user, some of the update information presented to the user can be regarded as an advertisement. Accordingly, the manufacturing source of the recording and playback device 11 may obtain an advertisement fee from the provider of the content on the basis of the actual results of the transmission of the update information in the update information distribution server 12.

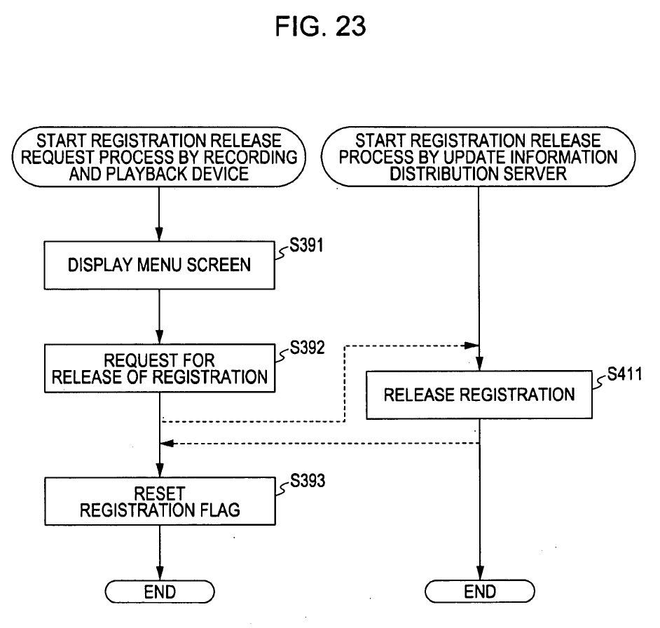

Furthermore, the user may release the registration of the recording and playback device 11 in the update information distribution server 12 so that the update information is not obtained. In such a case, for example, processing shown in the flowchart of FIG. 23 is performed.

FIG. 23 is a flowchart illustrating a registration release request process and a registration release process performed by the recording and playback device 11 and the update information distribution server 12, respectively.

In a state in which the optical disc 41 has not been inserted into the recording and playback device 11, when the user operates the input unit 52 and instructs the display of the menu screen, an operation signal in response to the operation of the user is supplied from the input unit 52 to the controller 54.

When the operation signal is supplied to the controller 54, in step S391, the controller 54 causes the display device 14 to display, for example, the menu screen of FIG. 11 on the basis of the meta-information and the update information recorded in the recorder 53.

After the menu screen is displayed, when the user further performs an operation on the input unit 52 in order to instruct the release of the registration of the recording and playback device 11 with regard to the content of a specific optical disc 41, an operation signal in response to the operation of the user is supplied from the input unit 52 to the controller 54.

In step S392, the controller 54 requests the update information distribution server 12 to release the registration of the recording and playback device 11 with regard to the content specified by the user via the communication unit 55. That is, the controller 54 reads, from the recorder 53, information for identifying the specified content and the recording and playback device 11, more specifically, the org ID, the disc ID, and the device ID, which are included in the meta-information of the specified content, and supplies them to the communication unit 55. The communication unit 55 transmits the org ID, the disc ID, and the device ID, which are supplied from the controller 54, to the update information distribution server 12, and requests for the release of the registration of the recording and playback device 11.

Then, in step S411, the update information distribution server 12 receives the org ID, the disc ID, and the device ID, which are transmitted from the recording and playback device 11, and performs the release of the registration of the recording and playback device 11 in response to the request by the recording and playback device 11. That is, with regard to the recording and playback device 11 identified by the received device ID, information on a list of update information for the content identified by the org ID and the disc ID is deleted, and the registration of the recording and playback device 11 is released. Therefore, after that, even if a request for the transmission of the update information is made with regard to the content identified by the org ID and the disc ID, the update information is not transmitted.

When the update information distribution server 12 releases the registration of the recording and playback device 11, the update information distribution server 12 transmits a report informing that the release of the registration has been completed to the recording and playback device 11, and the registration release process is completed.

Furthermore, the communication unit 55 of the recording and playback device 11 receives the report informing that the release of the registration has been completed, which is transmitted from the update information distribution server 12, and supplies it to the controller 54. The controller 54 supplies the report supplied from the communication unit 55 to the display device 14, whereby the report informing that the release of the registration has been completed is displayed.

In step S393, the controller 54 resets the registration flag recorded in the recorder 53, and thus the registration release request process is completed. When the registration flag is reset, the update information of the content corresponding to the registration flag is not obtained.

In the manner described above, the recording and playback device 11 requests the update information distribution server 12 to release the registration of the recording and playback device 11, and resets the registration flag. By requesting for the release of the registration in the manner described above, it is possible to prevent the update information from being unnecessarily obtained.

The above-described series of processes can be performed by hardware or software. When the series of processing is to be performed by software, a program constituting the software is installed from a program recording medium into a computer that is incorporated in specialized hardware, or such a program is installed from a program recording medium into a general-purpose computer capable of performing various processes by installing various programs.

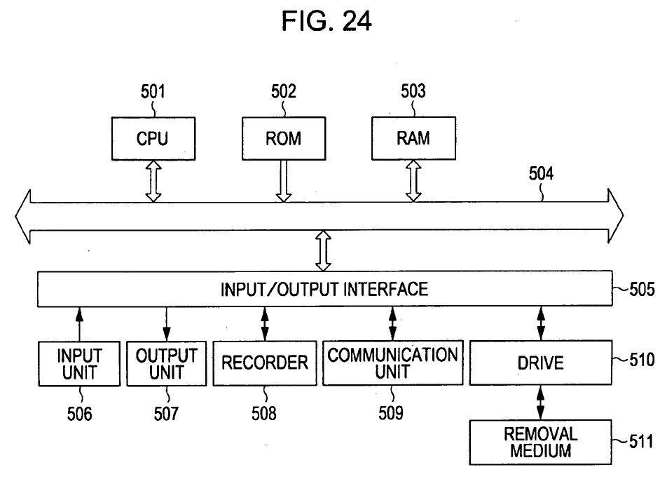

FIG. 24 is a block diagram showing an example of the configuration of hardware of a computer that executes the above-described series of processes in accordance with programs.

In the computer, a CPU (Central Processing Unit) 501, a ROM (Read Only Memory) 502, and a RAM (Random Access Memory) 503 are interconnected with one another through a bus 504.

Furthermore, an input/output interface 505 is connected to the bus 504. An input unit 506 including a keyboard, a mouse, a microphone, and the like, an output unit 507 including a display, a speaker, and the like, a recorder 508 including a hard disk, non-volatile memory, and the like, a communication unit 509 including a network interface and the like, and a drive 510 for driving a removable medium 511, such as a magnetic disc, an optical disc, a magneto-optical disc, or a semiconductor memory, are connected to the input/output interface 505.

In the computer configured as described above, the CPU 501 loads, for example, a program recorded in the recorder 508 to the RAM 503 via the input/output interface 505 and the bus 504, and executes the program, thereby performing the above-described series of processes.

The program executed by the computer (CPU 501) is provided in such a manner as to be recorded on a removable medium 511 that is a packaged medium, for example, a magnetic disc (including a flexible disk), an optical disc (a CD-ROM (Compact Disc-Read Only Memory), a DVD, etc.), a magneto-optical disc, or a semiconductor memory. Alternatively, the program is provided via a wired or wireless transmission medium, such as a local area network, the Internet, or a digital satellite broadcast.

The program can be installed into the recorder 508 via the input/output interface 505 by installing the removable medium 511 into the drive 510. Furthermore, the program can be received by the communication unit 509 via a wired or wireless transmission medium and installed into the recorder 508. In addition, the program can be pre-installed into the ROM 502 and the recorder 508.

The program executed by the computer may be a program with which processes are performed in chronological order according to the order described in the specification, or may be a program with which processes are performed in parallel or at a necessary time when the program is called, or the like.

The embodiments of the present invention are not limited to the above-described embodiments, and various changes are possible within the scope and spirit of the present invention.

The present application contains subject matter related to that disclosed in Japanese Priority Patent Application JP 2008-100234 filed in the Japan Patent Office on Apr. 8, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An electronic apparatus comprising:
reading means for reading, from a removable content recording medium on which at least one content item among a plurality of content items purchased by a user is recorded, playback rights information indicating that the plurality of content items can be played back, and position information indicating a recording destination of information regarding unrecorded content that is content that has not been recorded on the content recording medium;
obtaining means for obtaining the unrecorded content on the basis of the position information via a network; and
playback control means for controlling playback of the obtained unrecorded content by using the playback rights information.

2. The electronic apparatus according to claim 1, wherein the obtaining means obtains update information informing that obtaining of the unrecorded content is possible on the basis of the position information, and obtains the unrecorded content on the basis of the update information.

3. The electronic apparatus according to claim 2, further comprising display control means for controlling display of the update information obtained by the obtaining means.

4. The electronic apparatus according to claim 3, further comprising recording control means for controlling recording of the unrecorded content obtained by the obtaining means onto the content recording medium.

5. The electronic apparatus according to claim 3, further comprising recording means for recording the unrecorded content obtained by the obtaining means.

6. The electronic apparatus according to claim 2, further comprising recording means for recording the update information obtained by the obtaining means,
wherein, when the obtaining means newly obtains update information, the obtaining means obtains update information that has not been recorded on the recording means by transmitting, to the recording destination, information indicating the update information that has already been obtained and recorded in the recording means.

7. The electronic apparatus according to claim 2, further comprising recording control means for controlling recording of the obtained playback rights information on a content recording medium,
wherein the obtaining means obtains update information regarding another plurality of content items related with the plurality of content and further obtains playback rights information on the other plurality of content items in such a manner as to correspond to the update information.

8. An information processing method comprising the steps of:
reading, from a removable content recording medium on which at least one content item among a plurality of content items purchased by a user, playback rights information indicating that the plurality of content items can be played back, and position information indicating a recording destination of information regarding unrecorded content that is content that has not been recorded on the content recording medium;
obtaining the unrecorded content on the basis of the position information via a network; and
controlling playback of the obtained unrecorded content by using the playback rights information.

9. A recording medium having recorded thereon a program, the program causing a computer to execute processing comprising the step of:
controlling reading of playback rights information indicating that the plurality of content items can be played back, and position information indicating a recording destination of information regarding unrecorded content that is content that has not been recorded on the content recording medium, from a removable content recording medium on which at least one content item among a plurality of content items purchased by a user is recorded; and
obtaining the unrecorded content on the basis of the position information via a network; and
controlling playback of the obtained unrecorded content by using the playback rights information.

10. A content recording medium on which at least one content item among a plurality of content items purchased by a user is recorded,
wherein the content recording medium has recorded thereon
playback rights information indicating that the plurality of content items can be played back in an electronic apparatus to which the content recording medium is loaded, and
position information indicating a recording destination of information regarding unrecorded content that is content that has not been recorded on the content recording medium.

11. An electronic apparatus comprising:
a reading unit configured to read, from a removable content recording medium on which at least one content item among a plurality of content items purchased by a user is recorded, playback rights information indicating that the plurality of content items can be played back, and position information indicating a recording destination of information regarding unrecorded content that is content that has not been recorded on the content recording medium;
an obtaining unit configured to obtain the unrecorded content on the basis of the position information via a network; and
a playback control unit configured to control playback of the obtained unrecorded content by using the playback rights information.
